(19) United States
(12) Patent Application Publication
(10) Pub. No.: US 2017/0244702 A1
(43) Pub. Date: Aug. 24, 2017

(54) ELECTRONIC APPARATUS HAVING AUTHENTICATION MODULE AND METHOD FOR AUTHENTICATING USER BY CONTROLLING AUTHENTICATION MODULE

(71) Applicant: SAMSUNG ELECTRONICS CO., LTD., Suwon-si (KR)

(72) Inventors: Ho-Dong JWA, Suwon-si (KR); Gwiho Lee, Uiwang-si (KR); Hakjoo Kim, Yongin-si (KR); Sangho Park, Anyang-si (KR); Yong-Jun Park, Suwon-si (KR); Kyungryol Lee, Suwon-si (KR); Wooyoung Choi, Hwaseong-si (KR)

(21) Appl. No.: 15/422,841

(22) Filed: Feb. 2, 2017

(30) Foreign Application Priority Data
Feb. 19, 2016 (KR) 10-2016-0020033

(51) Int. Cl. H04L 29/06

(52) U.S. Cl. CPC H04L 63/0861; H04L 63/10; H04L 63/083

(57) ABSTRACT

According to various example embodiments of the present disclosure, an electronic device and an operating method thereof may include receiving an access request for the electronic device from an external electronic device, activating the authentication module in response to the access request, transmitting, to the external electronic device, an authentication information request for the authentication module, receiving, from the external electronic device, authentication information corresponding to a user of the external electronic device in response to the authentication information request, performing authentication on the user based on the authentication information using the authentication module, and deactivating the authentication module if the authentication is complete.

According to various example embodiments of the present disclosure, an electronic device and an operating method thereof may include establishing a communication connection with a plurality of external devices, requesting the plurality of external devices for identification information, receiving the identification information from at least one of the plurality of external devices in response to the identification information request, and cancelling the request to at least one external device different from the at least one of the plurality of external devices based on receiving the identification information.

### CROSS-REFERENCE TO RELATED APPLICATION

This application is based on and claims priority under 35 U.S.C. §119 to a Korean patent application filed in the Korean Intellectual Property Office on Feb. 19, 2016 and assigned Serial No. 10-2016-0020033, the disclosure of which is incorporated by reference herein in its entirety.

### BACKGROUND

1. Field of the Disclosure

The present disclosure relates generally to an electronic device and an operating method thereof.

2. Description of Related Art

Recently, since privacy information protection or the like becomes more important, a service having a high security level is more increased through iris recognition, fingerprint recognition, or the like. In a method used at present, an electronic device converts bio information of a user into digital information, and the digital information is encrypted to be used as user authentication information. The electronic device performs user authentication by receiving, in a wired manner, bio information recognized in a bio sensor included in the electronic device which intends to perform authentication or bio information recognized in an external bio sensor provided outside the electronic device.

The aforementioned electronic device has a problem in that user authentication is impossible if the bio sensor is not included in the electronic device which intends to perform the user authentication or the bio sensor is not connected.

### SUMMARY

To address the above problem, various example embodiments of the present disclosure relate to an electronic device capable of providing an authentication function through bio recognition in heterogeneous electronic devices, and an operating method thereof.

According to various example embodiments, an electronic device may include a display, a communication circuit, an authentication module comprising authentication circuitry, and a processor, wherein the processor is configured to receive an identification request for the electronic device from an external electronic device using the communication circuit, to activate the authentication module in response to the identification request, to transmit, to the external electronic device, an authentication information request for the authentication module, to receive, from the external electronic device, authentication information corresponding to a user of the external electronic device in response to the authentication information request, to perform authentication based on the authentication information using the authentication module, and to deactivate the authentication module if the authentication is complete.

According to various example embodiments, a method of operating an electronic device may include receiving an access request for the electronic device from an external electronic device, activating an authentication module in response to the access request, transmitting, to the external electronic device, an authentication information request for the authentication module, receiving, from the external electronic device, authentication information corresponding to a user of the external electronic device in response to the authentication information request, performing authentication based on the authentication information by using the authentication module, and deactivating the authentication module if the authentication is complete.

According to various example embodiments, a recording medium may record a program for executing operations of receiving an access request for the electronic device from an external electronic device, activating the authentication module in response to the access request, transmitting, to the external electronic device, an authentication information request for the authentication module, receiving, from the external electronic device, authentication information corresponding to a user of the external electronic device in response to the authentication information request, performing authentication based on the authentication information by using the authentication module, and deactivating the authentication module if the authentication is complete.

According to various example embodiments, an electronic device may include a communication unit comprising communication circuitry configured to connect the electronic device with a plurality of external devices, and a processor operatively coupled to the communication unit, wherein the processor is configured to request the plurality of external devices for identification information, to receive the identification information from at least one of the plurality of external devices in response to the identification information request, and to cancel the request to at least one external device different from the at least one of the plurality of external devices based on receiving the identification information.

According to various example embodiments, a method of operating an electronic device may include connecting with a plurality of external devices, requesting the plurality of external devices for identification information, receiving the identification information from at least one of the plurality of external devices in response to the identification information request, and cancelling the request to at least one external device different from the at least one of the plurality of external devices based on receiving the identification information.

According to various example embodiments, a recording medium may record a program for executing operations of connecting communication with a plurality of external devices, requesting the plurality of external devices for identification information, receiving the identification information from at least one of the plurality of external devices in response to the identification information request, and cancelling the request to at least one external device different from the at least one of the plurality of external devices based on receiving the identification information.

### BRIEF DESCRIPTION OF THE DRAWINGS

The above and other features, aspects and attendant advantages of the present disclosure will become more apparent and readily appreciated from the following detailed description, taken in conjunction with the accompanying drawings, in which like reference numerals refer to like elements, and wherein:

FIG. 1 is a block diagram illustrating an example electronic device in a network environment system according to various example embodiments;

FIG. 2 is a block diagram illustrating an example electronic device according to various example embodiments;

FIG. 3 is a block diagram illustrating an example program module according to various example embodiments;

FIG. 4 is a block diagram illustrating an example communication system according to various example embodiments;

FIG. 5 is a flowchart illustrating an example method of registering bio information in a communication system according to various example embodiments;

FIG. 6 is a flowchart illustrating an example method of authenticating bio information in a communication system according to various example embodiments;

FIGS. 7A and 7B are flowcharts illustrating an example method of operating a 1^{st} electronic device according to various example embodiments;

FIG. 8 is a flowchart illustrating an example method of operating a 2^{nd} electronic device according to various example embodiments;

FIGS. 9A and 9B are flowcharts illustrating an example method of operating a 2^{nd} electronic device according to various example embodiments;

FIG. 10 is a flowchart illustrating an example method of registering bio information in a communication system according to various example embodiments;

FIG. 11 is a flowchart illustrating an example method of registering bio information in a communication system according to various example embodiments;

FIG. 12 is a flowchart illustrating an example method of registering bio information in a communication system according to various example embodiments;

FIG. 13 is a flowchart illustrating an example method of operating a 1^{st} electronic device according to various example embodiments;

FIG. 14 is a flowchart illustrating an example method of operating a 2^{nd} electronic device according to an example embodiment;

FIG. 15 is a flowchart illustrating an example method of operating a 2^{nd} electronic device according to another example embodiment;

FIG. 16 is a flowchart illustrating an example method of authenticating bio information in a communication system according to various example embodiments;

FIG. 17 is a flowchart illustrating an example method of authenticating bio information in a communication system according to various example embodiments;

FIG. 18 is a flowchart illustrating an example method of recognizing bio information in a communication system according to various example embodiments;

FIG. 19 is a flowchart illustrating an example method of operating a 1^{st} electronic device according to various example embodiments;

FIG. 20 is a flowchart illustrating an example method of operating a 2^{nd} electronic device according to an example embodiment; and

FIG. 21 is a flowchart illustrating an example method of operating a 2^{nd} electronic device according to another example embodiment.

### DETAILED DESCRIPTION

Various example embodiments of the present disclosure are described in greater detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure. The terms used herein are defined in consideration of functions of the present disclosure and may vary depending on a user's or an operator's intention and usage. Therefore, the terms used herein should be understood based on the descriptions made herein. It is to be understood that the singular forms “a,” “an,” and “the” include plural referents unless the context clearly dictates otherwise. In the present disclosure, an expression such as “A or B,” “at least one of A and B,” or “one or more of A and B” may include all possible combinations of the listed items. Expressions such as “first,” “second,” “primarily,” or “secondary,” as used herein, may represent various elements regardless of order and/or importance and do not limit corresponding elements. The expressions may be used for distinguishing one element from another element. When it is described that an element (such as a first element) is “(operatively or communicatively) coupled” to or “connected” to another element (such as a second element), the element can be directly connected to the other element or can be connected through another element (such as a third element).

An expression “configured to (or set)” used in the present disclosure may be used interchangeably with, for example, “suitable for,” “having the capacity to,” “designed to,” “adapted to,” “made to,” or “capable of” according to a situation. A term “configured to (or set)” does not only refer to “specifically designed to” by hardware. In some situations, the expression “apparatus configured to” may refer to a situation in which the apparatus “can” operate together with another apparatus or component. For example, a phrase “a processor configured (or set) to perform A, B, and C” may refer to a dedicated processor, a generic-purpose processor (such as a Central Processing Unit (CPU) or an application processor) that can perform a corresponding operation by executing at least one software program stored at an exclusive processor (such as an embedded processor) for performing a corresponding operation or at a memory device.

An electronic device according to embodiments of the present disclosure, may be embodied as, for example, at least one of a smart phone, a tablet Personal Computer (PC), a mobile phone, a video phone, an e-book reader, a desktop PC, a laptop PC, a netbook computer, a workstation, a server, a Personal Digital Assistant (PDA), a Portable Multimedia Player (PMP), an MPEG 3 (MP3) player, a medical equipment, a camera, and a wearable device, or the like, but is not limited thereto. The wearable device can include at least one of an accessory type (e.g., a watch, a ring, a bracelet, an ankle bracelet, a necklace, glasses, a contact lens, or a Head-Mounted-Device (HMD)), a fabric or clothing embedded type (e.g., electronic garments), a body attachable type (e.g., a skin pad or a tattoo), and an implantable circuit, or the like, but is not limited thereto. The electronic device may be embodied as at least one of, for example, a television, a Digital Versatile Disc (DVD) player, an audio device, a refrigerator, an air-conditioner, a cleaner, an oven, a microwave oven, a washing machine, an air cleaner, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, and an electronic frame, or the like, but is not limited thereto.

In another embodiment, the electronic device may be embodied as at least one of various medical devices (such as, various portable medical measuring devices (a blood sugar measuring device, a heartbeat measuring device, a blood pressure measuring device, or a body temperature measuring device), a Magnetic Resonance Angiography (MRA) device, a Magnetic Resonance Imaging (MRI) device, a Computed Tomography (CT) device, a scanning machine, and an ultrasonic wave device), a navigation device, a Global Navigation Satellite System (GNSS), an Event Data Recorder (EDR), a Flight Data Recorder (FDR), a vehicle infotainment device, electronic equipment for ship (such as, a navigation device for ship and gyro compass), avionics, a security device, a head unit for a vehicle, an industrial or home robot, a drone, an Automated Teller Machine (ATM) of a financial institution, a Point Of Sales (POS) device of a store, and an Internet of Things (IoT) device (e.g., a light bulb, various sensors, a sprinkler device, a fire alarm, a thermostat, a street light, a toaster, sports equipment, a hot water tank, a heater, and a boiler), or the like but is not limited thereto. According to an embodiment, the electronic device may be embodied as at least one of a portion of furniture, building/construction or vehicle, an electronic board, an electronic signature receiving device, a projector, and various measuring devices (e.g., water supply, electricity, gas, or electric wave measuring device), or the like, but is not limited thereto. An electronic device, according to an embodiment, can be a flexible electronic device or a combination of two or more of the foregoing various devices. An electronic device, according to an embodiment of the present disclosure, is not limited to the foregoing devices may be embodied as a newly developed electronic device. The term “user”, as used herein, can refer to a person using an electronic device or a device using an electronic device (e.g., an artificial intelligence electronic device).

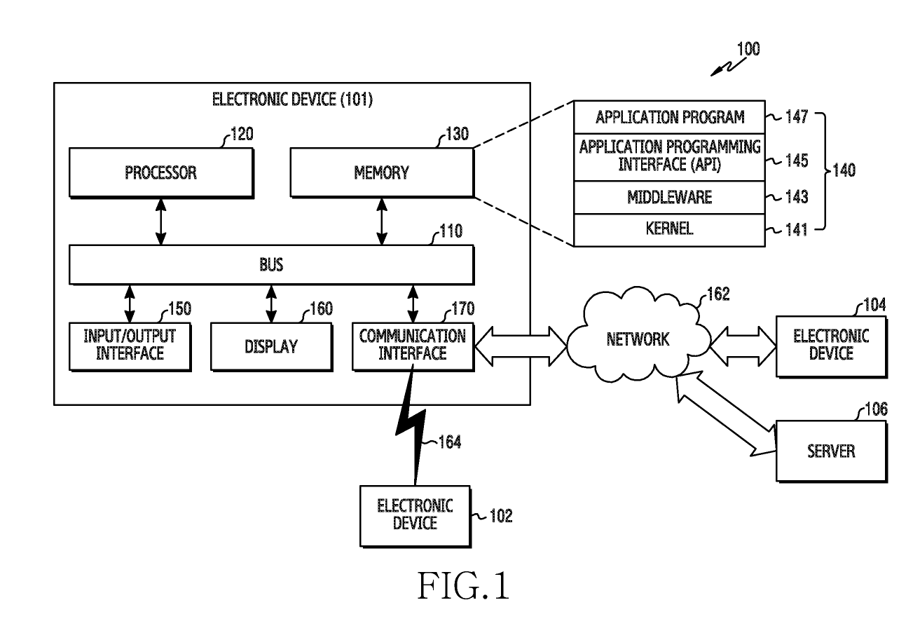

Referring initially to FIG. 1, an electronic device 101 resides in a network environment 100. The electronic device 101 can include a bus 110, a processor (e.g., including processing circuitry) 120, a memory 130, an input/output interface (e.g., including input/output circuitry) 150, a display 160, and a communication interface (e.g., including communication circuitry) 170. The electronic device 101 may be provided without at least one of the components, or may include at least one additional component. The bus 110 can include a circuit for connecting the components 120 through 170 and delivering communication signals (e.g., control messages or data) therebetween. The processor 120 may include various processing circuitry, such as, for example, and without limitation, one or more of a dedicated processor, a CPU, an application processor, and a Communication Processor (CP). The processor 120, for example, can perform an operation or data processing with respect to control and/or communication of at least another component of the electronic device 101.

The memory 130 can include a volatile and/or nonvolatile memory. The memory 130, for example, can store commands or data relating to at least another component of the electronic device 101. According to an embodiment, the memory 130 can store software and/or a program 140. The program 140 can include, for example, a kernel 141, middleware 143, an Application Programming Interface (API) 145, and/or an application program (or “application”) 147. At least part of the kernel 141, the middleware 143, or the API 145 can be referred to as an Operating System (OS). The kernel 141 can control or manage system resources (e.g., the bus 110, the processor 120, or the memory 130) used for performing operations or functions implemented by the other programs (e.g., the middleware 143, the API 145, or the application program 147). Additionally, the kernel 141 can provide an interface for controlling or managing system resources by accessing an individual component of the electronic device 101 from the middleware 143, the API 145, or the application program 147.

The middleware 143, for example, can serve an intermediary role for exchanging data between the API 145 or the application program 147 and the kernel 141 through communication. Additionally, the middleware 143 can process one or more job requests received from the application program 147, based on their priority. For example, the middleware 143 can assign a priority for using a system resource (e.g., the bus 110, the processor 120, or the memory 130) of the electronic device 101 to at least one of the application programs 147, and process the one or more job requests. The API 145, as an interface through which the application 147 controls a function provided from the kernel 141 or the middleware 143, can include, for example, at least one interface or function (e.g., an instruction) for file control, window control, image processing, or character control.

The input/output interface 150 may include various input/output circuitry and, for example, can deliver commands or data inputted from a user or another external device to other component(s) of the electronic device 101, or output commands or data input from the other component(s) of the electronic device 101 to the user or another external device.

The display 160, for example, can include a Liquid Crystal Display (LCD), a Light Emitting Diode (LED) display, an Organic Light Emitting Diode (OLED) display, a MicroElectroMechanical Systems (MEMS) display, or an electronic paper display, or the like, but is not limited thereto. The display 160, for example, can display various contents (e.g., texts, images, videos, icons, and/or symbols) to the user. The display 160 can include a touch screen, for example, and receive touch, gesture, proximity, or hovering inputs by using an electronic pen or a user's body part.

The communication interface 170, for example, may include various communication circuitry and can set a communication between the electronic device 101 and an external device (e.g., a first external electronic device 102, a second external electronic device 104, or a server 106). For example, the communication interface 170 can communicate with the external device (e.g., the second external electronic device 104 or the server 106) over a network 162 through wireless communication 164 or wired communication.

The wireless communication, for example, can include cellular communication using at least one of Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM). The wireless communication can include, for example, at least one of Wireless Fidelity (WiFi), Bluetooth, Bluetooth Low Energy (BLE), Zigbee, Near Field Communication (NFC), magnetic secure transmission, Radio Frequency (RF), and Body Area Network (BAN). The wireless communication can include GNSS.

The GNSS can include, for example, Global Positioning System (GPS), Global Navigation Satellite System (GLONASS), Beidou navigation satellite system (Beidou), or Galileo (the European global satellite-based navigation system). Hereafter, the GPS can be interchangeably used with the GNSS. The wired communication, for example, can include at least one of Universal Serial Bus (USB), High Definition Multimedia Interface (HDMI), Recommended Standard 232 (RS-232), power line communications, and Plain Old Telephone Service (POTS). The network 162 can include a telecommunications network, for example, at least one of computer network (e.g., LAN or WAN), Internet, and telephone network.

Each of the first and second external electronic devices 102 and 104 can be of the same as or of a different type from that of the electronic device 101. According to embodiments of the present disclosure, all or part of operations executed in the electronic device 101 can be executed by another electronic device or a plurality of electronic devices (e.g., the electronic device 102 or 104, or the server 106). To perform a function or service automatically or by request, instead of performing the function or the service by the electronic device 101, the electronic device 101 can request at least part of a function relating thereto from another device (e.g., the electronic device 102 or 104, or the server 106). The other electronic device (e.g., the electronic device 102 or 104, or the server 106) can perform the requested function or an additional function and send its result to the electronic device 101. The electronic device 101 can provide the requested function or service by processing the received result. In doing so, for example, cloud computing, distributed computing, or client-server computing techniques can be used.

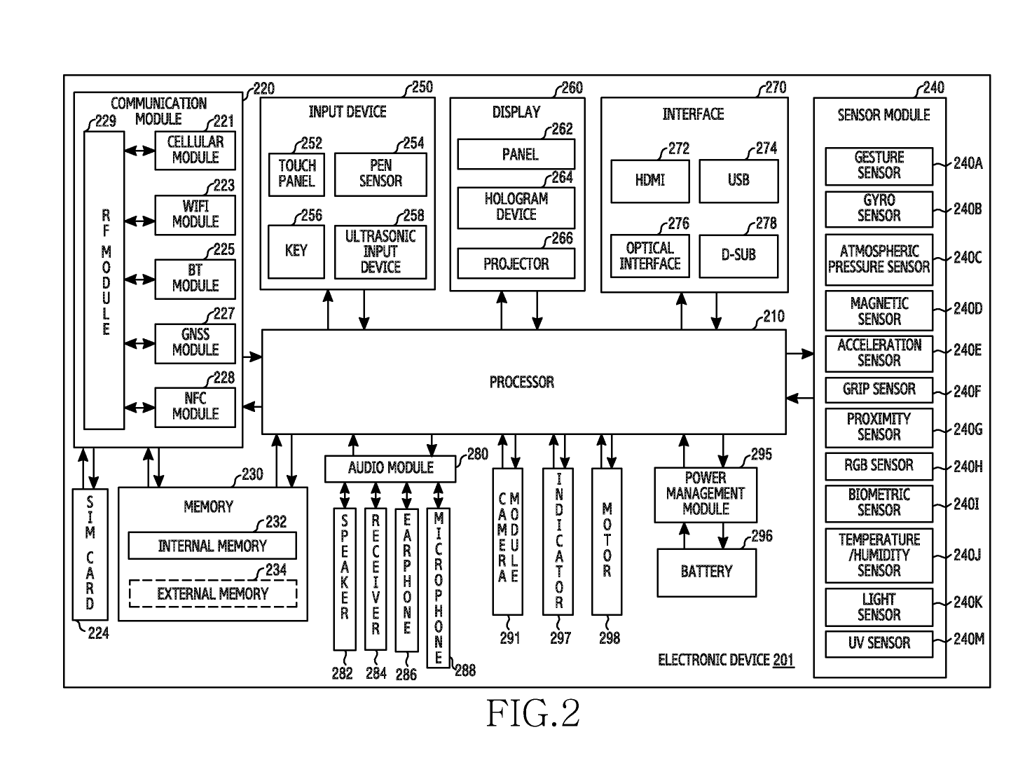

FIG. 2 is a block diagram illustrating an example electronic device 201 according to an example embodiment of the present disclosure. The electronic device 201, for example, can include all or part of the above-described electronic device 101 of FIG. 1. The electronic device 201 includes one or more processors (e.g., an AP) (e.g., including processing circuitry) 210, a communication module (e.g., including communication circuitry) 220, a Subscriber Identification Module (SIM) 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210, for example, may include various processing circuitry and can control a plurality of hardware or software components connected to the processor 210, and also can perform various data processing and operations by executing an OS or an application program. The processor 210 can be implemented with a System on Chip (SoC), for example. The processor 210 can further include a Graphic Processing Unit (GPU) and/or an image signal processor. The processor 210 may include at least part (e.g., a cellular module 221) of the components shown in FIG. 2. The processor 210 can load commands or data received from at least one other component (e.g., a nonvolatile memory) into a volatile memory, process them, and store various data in the nonvolatile memory.

The communication module 220 can have the same or similar configuration to the communication interface 170 of FIG. 1. The communication module 220 may include various communication circuitry, such as, for example, and without limitation, the cellular module 221, a WiFi module 223, a Bluetooth (BT) module 225, a GNSS module 227, an NFC module 228, and an RF module 229. The cellular module 221, for example, can provide voice call, video call, Short Message Service (SMS), or Internet service through a communication network. The cellular module 221 can identify and authenticate the electronic device 201 in a communication network by using the SIM (e.g., a SIM card) 224.

The cellular module 221 can perform at least part of a function that the processor 210 provides. The cellular module 221 can further include a CP. At least some (e.g., two or more) of the cellular module 221, the WiFi module 223, the BT module 225, the GNSS module 227, and the NFC module 228 can be included in one Integrated Circuit (IC) or an IC package. The RF module 229, for example, can transmit/receive a communication signal (e.g., an RF signal). The RF module 229, for example, can include a transceiver, a Power Amp Module (PAM), a frequency filter, a Low Noise Amplifier (LNA), or an antenna. According to another embodiment, at least one of the cellular module 221, the WiFi module 223, the BT module 225, the GNSS module 227, and the NFC module 228 can transmit/receive an RF signal through an additional RF module. The SIM 224, for example, can include a card including a SIM or an embedded SIM, and also can contain unique identification information (e.g., an Integrated Circuit Card Identifier (ICCID)) or subscriber information (e.g., an International Mobile Subscriber Identity (IMSI)).

The memory 230 (e.g., the memory 130) can include at least one of an internal memory 232 and/or an external memory 234. The internal memory 232 can include at least one of, for example, a volatile memory (e.g., Dynamic RAM (DRAM), Static RAM (SRAM), or Synchronous Dynamic RAM (SDRAM)), and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, flash memory, hard drive, and solid state drive (SSD)). The external memory 234 can include flash drive, for example, Compact Flash (CF), Secure Digital (SD), micro SD, mini SD, extreme digital (xD), Multi-Media Card (MMC), or memory stick. The external memory 234 can be functionally or physically connected to the electronic device 201 through various interfaces.

The sensor module 240 can, for example, measure physical quantities or detect an operating state of the electronic device 201, and thus convert the measured or detected information into electrical signals. The sensor module 240 can include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a Red, Green, Blue (RGB) sensor), a bio (e.g., biometric) sensor 240I, a temperature/humidity sensor 240J, an illumination (e.g., light) sensor 240K, and an Ultra Violet (UV) sensor 240M. Additionally or alternately, the sensor module 240 can include an E-nose sensor, an Electromyography (EMG) sensor, an Electroencephalogram (EEG) sensor, an Electrocardiogram (ECG) sensor, an InfraRed (IR) sensor, an iris sensor, and/or a fingerprint sensor. The sensor module 240 can further include a control circuit for controlling at least one sensor therein. The electronic device, as part of the processor 210 or individually, can further include a processor configured to control the sensor module 240 and thus control the sensor module 240 while the processor 210 is sleeping.

The input device 250 may include various input circuitry, such as, for example, and without limitation, at least one of a touch panel 252, a (digital) pen sensor 254, a key 256, and an ultrasonic input device 258. The touch panel 252 can use at least one of, for example, capacitive, resistive, infrared, and ultrasonic methods. Additionally, the touch panel 252 can further include a control circuit. The touch panel 252 can further include a tactile layer to provide a tactile response to a user. The (digital) pen sensor 254 can include, for example, part of a touch panel or a sheet for recognition. The key 256 can include, for example, a physical button, a touch key, an optical key, or a keypad. The ultrasonic input device 258 can detect ultrasonic waves from an input means through a microphone 288 and check data corresponding to the detected ultrasonic waves.

The display 260 (e.g., the display 160) can include at least one of a panel 262, a hologram device 264, a projector 266, and/or a control circuit for controlling them. The panel 262 can be implemented to be flexible, transparent, or wearable, for example. The panel 262 and the touch panel 252 can be configured with one or more modules. The panel 262 can include a pressure sensor (or a force sensor) for measuring a pressure of the user touch. The pressure sensor can be integrated with the touch panel 252, or include one or more sensors separately from the touch panel 252. The hologram device 264 can show three-dimensional images in the air by using the interference of light. The projector 266 can display an image by projecting light on a screen. The screen, for example, can be placed inside or outside the electronic device 201.

The interface 270 may include various interface circuitry, such as, for example, and without limitation, an HDMI 272, a USB 274, an optical interface 276, or a D-subminiature (D-sub) 278. The interface 270 can be included in, for example, the communication interface 170 of FIG. 1. Additionally or alternately, the interface 270 can include a Mobile High-Definition Link (MHL) interface, a SD card/MMC interface, or an Infrared Data Association (IrDA) standard interface.

The audio module 280, for example, can convert sounds into electrical signals and convert electrical signals into sounds. At least some components of the audio module 280 can be included in, for example, the input/output interface 150 of FIG. 1. The audio module 280 can process sound information inputted or outputted through a speaker 282, a receiver 284, an earphone 286, or the microphone 288. The camera module 291, as a device for capturing still images and videos, can include one or more image sensors (e.g., a front sensor or a rear sensor), a lens, an Image Signal Processor (ISP), or a flash (e.g., an LED or a xenon lamp). The power management module 295, for example, can manage the power of the electronic device 201. According to an embodiment of the present disclosure, the power management module 295 can include a Power Management IC (PMIC), a charger IC, or a battery or fuel gauge, for example. The PMIC can have a wired and/or wireless charging method. The wireless charging method can include, for example, a magnetic resonance method, a magnetic induction method, or an electromagnetic method, and can further include an additional circuit for wireless charging, for example, a coil loop, a resonant circuit, or a rectifier circuit. The battery gauge can measure the remaining capacity of the battery 296, or a voltage, current, or temperature of the battery 296 during charging. The battery 296 can include, for example, a rechargeable battery and/or a solar battery.

The indicator 297 can display a specific state of the electronic device 201 or part thereof (e.g., the processor 210), for example, a booting state, a message state, or a charging state. The motor 298 can convert electrical signals into mechanical vibration and generate a vibration or haptic effect. The electronic device 201 can include a mobile TV supporting device (e.g., a GPU) for processing media data according to standards such as Digital Multimedia Broadcasting (DMB), Digital Video Broadcasting (DVB), or MediaFLOW™.

Each of the above-described components of the electronic device can be configured with at least one component and the name of a corresponding component can vary according to the kind of an electronic device. According to an embodiment of the present disclosure, an electronic device (e.g., the electronic device 201) can be configured to include at least one of the above-described components or an additional component, or to not include some of the above-described components. Additionally, some of components in an electronic device are configured as one entity, so that functions of previous corresponding components are performed identically.

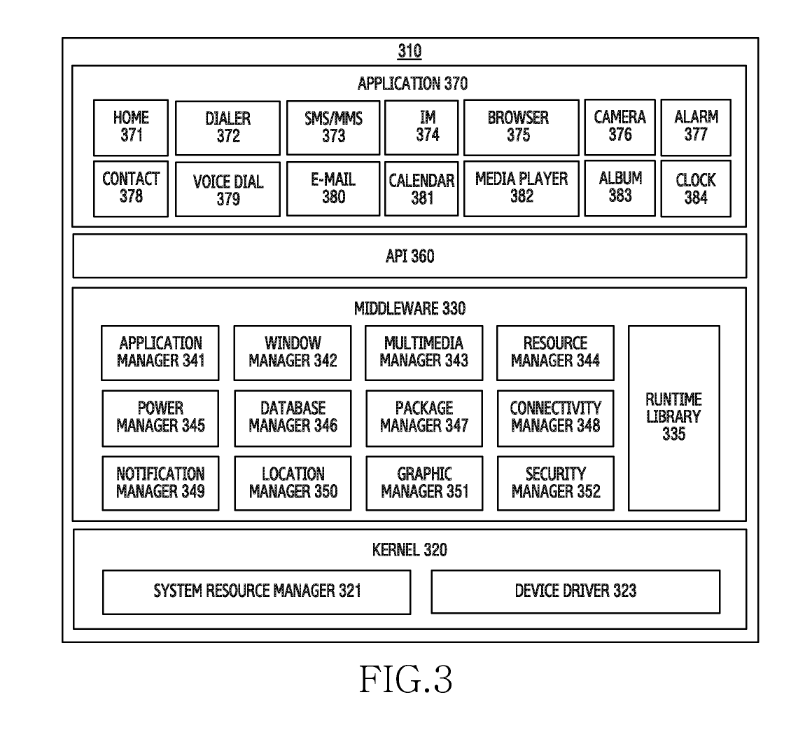

FIG. 3 is a block diagram illustrating an example program module according to an embodiment of the present disclosure. A program module 310 (e.g., the program 140) can include an OS for controlling a resource relating to an electronic device (e.g., the electronic device 101) and/or various applications (e.g., the application program 147) running on the OS. The OS can include, for example, Android™, iOS™, Windows™, Symbian™, Tizen™, or Bada™. Referring to FIG. 3, the program module 310 can include a kernel 320 (e.g., the kernel 141), a middleware 330 (e.g., the middleware 143), an API 360 (e.g., the API 145), and/or an application 370 (e.g., the application program 147). At least part of the program module 310 can be preloaded on an electronic device or can be downloaded from an external electronic device (e.g., the electronic device 102, 104, or the server 106).

The kernel 320 includes, for example, at least one of a system resource manager 321 and/or a device driver 323. The system resource manager 321 can control, allocate, or retrieve a system resource. According to an embodiment, the system resource manager 321 can include a process management unit, a memory management unit, or a file system management unit. The device driver 323 can include, for example, a display driver, a camera driver, a Bluetooth driver, a sharing memory driver, a USB driver, a keypad driver, a WiFi driver, an audio driver, or an Inter-Process Communication (IPC) driver.

The middleware 330, for example, can provide a function commonly required by the application 370, or can provide various functions to the application 370 through the API 360 in order to allow the application 370 to efficiently use a limited system resource inside the electronic device. The middleware 330 includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 can include, for example, a library module used by a complier to add a new function through a programming language while the application 370 is running. The runtime library 335 can manage input/output, manage memory, or arithmetic function processing. The application manager 341, for example, can manage the life cycle of the applications 370. The window manager 342 can manage a GUI resource used in a screen. The multimedia manager 343 can recognize a format for playing various media files and encode or decode a media file by using the codec in a corresponding format. The resource manager 344 can manage a source code of the application 3740 or a memory space. The power manager 345 can manage the capacity or power of the battery and provide power information for an operation of the electronic device. The power manager 345 can operate together with a Basic Input/Output System (BIOS). The database manager 346 can create, search, or modify a database used in the application 370. The package manager 347 can manage installation or updating of an application distributed in a package file format.

The connectivity manger 348 can manage, for example, a wireless connection. The notification manager 349 can provide an event, such as incoming messages, appointments, and proximity alerts, to the user. The location manager 350 can manage location information of an electronic device. The graphic manager 351 can manage a graphic effect to be provided to the user or a user interface relating thereto. The security manager 352 can provide, for example, system security or user authentication. The middleware 330 can include a telephony manager for managing a voice or video call function of the electronic device, or a middleware module for combining various functions of the above-described components. The middleware 330 can provide a module specialized for each type of OS. The middleware 330 can dynamically delete part of the existing components or add new components. The API 360, as a set of API programming functions, can be provided as another configuration according to the OS. For example, Android or iSO can provide one API set for each platform, and Tizen can provide two or more API sets for each platform.

The application 370 can include at least one of a home 371, a dialer 372, an SMS/Multimedia Messaging System (MMS) 373, an Instant Message (IM) 374, a browser 375, a camera 376, an alarm 377, a contact 378, a voice dial 379, an e-mail 380, a calendar 381, a media player 382, an album 383, a clock 384, health care (e.g., measure an exercise amount or blood sugar level), or environmental information (e.g., air pressure, humidity, or temperature information) provision application. The application 370 can include an information exchange application for supporting information exchange between the electronic device and an external electronic device. The information exchange application can include, for example, a notification relay application for relaying specific information to the external device or a device management application for managing the external electronic device. For example, the notification relay application can relay notification information from another application of the electronic device to an external electronic device, or receive and forward notification information from an external electronic device to the user. The device management application, for example, can install, delete, or update a function (e.g., turn-on/turn off of the external electronic device itself (or some components) or display brightness (or resolution) adjustment) of an external electronic device communicating with the electronic device, or an application operating in the external electronic device. The application 370 can include a specified application (e.g., a health care application of a mobile medical device) according to a property of the external electronic device. The application 370 can include an application received from an external electronic device. At least part of the program module 310 can be implemented (e.g., executed) with software, firmware, hardware (e.g., the processor 210), or a combination of at least two of them, and include a module, a program, a routine, a set of instructions, or a process for executing one or more functions.

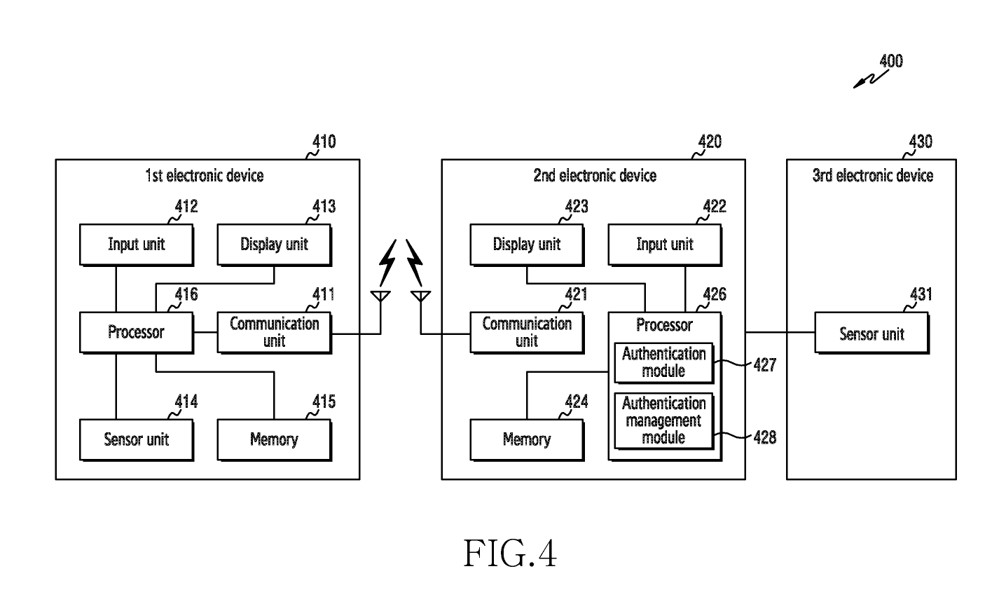

FIG. 4 is a block diagram illustrating an example communication system 400 according to various example embodiments.

Referring to FIG. 4, the communication system 400 according to various example embodiments may include a plurality of electronic devices 410, 420, and 430. For example, the electronic devices 410, 420, and 430 may include a 1^{st} electronic device 410, a 2^{nd} electronic device 420, and a 3^{rd} electronic device 430. The 1^{st} electronic device 410, the 2^{nd} electronic device 420, and the 3^{rd} electronic device 430 may be different types of devices, and at least any two of the 1^{st} electronic device 410, the 2^{nd} electronic device 420, and the 3^{rd} electronic device 430 may be the same type of devices. At least any two of the 1^{st} electronic device 410, the 2^{nd} electronic device 420, and the 3^{rd} electronic device 430 may mutually connect to each other to perform communication.

The 1^{st} electronic device 410 may be operated having mobility. That is, the 1^{st} electronic device 410 may be moved by being carried by a user. According to various example embodiments, the 1^{st} electronic device 410 may include a communication unit (e.g., including communication circuitry) 411, an input unit (e.g., including input circuitry) 412, a display unit 413, a sensor unit 414, a memory 415, and a processor (e.g., including processing circuitry) 416.

The communication unit 411 may include various communication circuitry configured to perform communication in the 1^{st} electronic device 410. In this case, the communication unit 411 may communicate with an external device by using various communication methods. For example, the communication unit 411 may perform communication in a wired or wireless manner. For this, the communication unit 411 may include at least one antenna. In addition, the communication unit 411 may have access to at least any one of a mobile communication network and a data communication network. The communication unit 411 may perform near-distance communication. For example, the external device may include at least any one of an electronic device, a base station, a server, and a satellite. According to various example embodiments, the external device may include at least any one of the 2^{nd} electronic device 420 and the 3^{rd} electronic device 430. Further, the communication method may include Long Term Evolution (LTE), Wideband Code Division Multiple Access (WCDMA), Global System for Mobile communications (GSM), Wireless Fidelity (WiFi), wireless Local Area Network (LAN), bluetooth, and Near Field Communications (NFC).

The input unit 412 may include various input circuitry configured to generate input data in the 1^{st} electronic device 410. In this case, the input unit 412 may include at least one input means. For example, the input unit 412 may include various input circuitry, such as, for example, and without limitation, at least any one of a key pad, a dome switch, a physical button, a touch panel, and a jog & shuttle.

The display unit 413 may output display data in the 1^{st} electronic device 410. For example, the display unit 413 may include a Liquid Crystal Display (LCD), a Light Emitting Diode (LED) display, an Organic Light Emitting Diode (OLED) display, an Active Matrix Light Emitting Diode (AMOLED) display, a Micro Electro Mechanical Systems (MEMS), and an electronic paper display. The display unit 413 may be implemented with a touch screen by being coupled to the input unit 412.

The sensor unit 414 may measure physical quantity around the 1^{st} electronic device 410. Alternatively, the sensor unit 414 may sense a state of the 1^{st} electronic device 410. That is, the sensor unit 414 may detect a physical signal. Further, the sensor unit 414 may convert the physical signal into an electrical signal. The sensor unit 414 may include at least one sensor. For example, the sensor unit 414 may include at least any one of a gesture sensor, a gyro sensor, a pressure sensor, a magnetic sensor, an acceleration sensor, a grip sensor, a proximity sensor, a color sensor (e.g., a Red, Green, Blue (RGB) sensor), a bio sensor, a temperature/humidity sensor, an illumination sensor, and an Ultra Violet (UV) sensor. For example, the bio sensor may include at least any one of an e-nose sensor, an ElectroMyoGraphy (EMG) sensor, an ElectroEncephaloGram (EEG) sensor, an ElectroCardioGram (ECG) sensor, an Infrared (IR) sensor, an iris sensor, and a fingerprint sensor.

The memory 415 may store operation programs of the 1^{st} electronic device 410. In addition, the memory 415 may store data generated while the programs are performed. Further, the memory 415 may store identification information of the user. The identification information may include at least any one of a password, a PIN code, a pattern, and bio information. For example, the bio information may include at least any one of small information, electromyogram information, brainwave information, electrocardiogram information, infrared information, iris information, and fingerprint information.

The processor 416 may include various processing circuitry configured to control an overall operation in the 1^{st} electronic device 410. In this case, the processor 416 may perform various functions. For this, the processor 416 may control constitutional elements of the 1^{st} electronic device 410. Further, the processor 416 may receive and process instructions or data from the constitutional elements of the 1^{st} electronic device 410. The processor 416 may acquire the identification information of the user. For this, the processor 416 may display a user interface to acquire the identification information. The processor 416 may register the identification information. For example, the processor 416 may extract only features contained in the identification information instead of the identification information itself for a security reason or the like (e.g., in case of the fingerprint information, points (feature points) which are unique features such as a location of a valley, peak, or the like or a rotation direction of a fingerprint pattern or the like are marked to extract information of a relative location, distance, or the like between respective points), and may store such feature information as at least one part of the identification information. For example, an operation of acquiring, using, or storing bio information may include an operation of acquiring, using, or storing the feature information.

The 2^{nd} electronic device 420 may be operated at a predetermined location. The 2^{nd} electronic device 420 may be operated having mobility. According to various example embodiments, the 2^{nd} electronic device 420 may include a communication unit (e.g., including communication circuitry) 421, an input unit (e.g., including input circuitry) 422, a display unit 423, a memory 424, an authentication module (e.g. including one or more of circuitry and/or a programming module) 427, and a processor (e.g., including processing circuitry) 426.

The communication unit 421 may include various communication circuitry configured to perform communication in the 2^{nd} electronic device 420. In this case, the communication unit 421 may communicate with an external device by using various communication methods. For example, the communication unit 421 may perform communication in a wired or wireless manner. For this, the communication unit 421 may include at least one antenna. Further, the communication unit 421 may have access to any one of a mobile communication network and a data communication network. Alternatively, the communication unit 421 may perform near-distance communication. For example, the external device may include at least any one of an electronic device, a base station, a server, and a satellite. According to various example embodiments, the external device may include at least any one of the 1^{st} electronic device 410 and the 3^{rd} electronic device 430. Further, the communication method may include Long Term Evolution (LTE), Wideband Code Division Multiple Access (WCDMA), Global System for Mobile communications (GSM), Wireless Fidelity (WiFi), wireless Local Area Network (LAN), bluetooth, and Near Field Communications (NFC).

The input unit 422 may generate input data in the 2^{nd} electronic device 420. In this case, the input unit 422 may include at least one input means. For example, the input unit 422 may include various input circuitry, such as, for example, and without limitation, at least any one of a key pad, a dome switch, a physical button, a touch panel, and a jog & shuttle.

The display unit 423 may output display data in the 2^{nd} electronic device 420. For example, the display unit 423 may include a Liquid Crystal Display (LCD), a Light Emitting Diode (LED) display, an Organic Light Emitting Diode (OLED) display, an Active Matrix Light Emitting Diode (AMOLED) display, a Micro Electro Mechanical Systems (MEMS), and an electronic paper display. The display unit 423 may be implemented with a touch screen by being coupled to the input unit 422.

The memory 424 may store operation programs of the 1^{st} electronic device 420. In addition, the memory 424 may store data generated while the programs are performed. According to various example embodiments, the memory 424 may register the 1^{st} electronic device 410. For example, the memory 424 may store reference information in association with the 1^{st} electronic device 410. Further, the memory 424 may store identification information of the user. The identification information may include at least any one of a password, a PIN code, a pattern, and bio information. For example, the bio information may include at least any one of small information, electromyogram information, brainwave information, electrocardiogram information, infrared information, iris information, and fingerprint information.

The processor 426 may include various processing circuitry configured to control an overall operation in the 2^{nd} electronic device 420. In this case, the processor 426 may perform various functions. For this, the processor 426 may control constitutional elements of the 2^{nd} electronic device 420. Further, the processor 426 may receive and process instructions or data from the constitutional elements of the 2^{nd} electronic device 420. The processor 426 may receive reference information from the 1^{st} electronic device 410. The processor 426 may register reference information in association with the 1^{st} electronic device 410. The processor 426 may acquire the identification information of the user. For example, the processor 426 may acquire bio information via the 3^{rd} electronic device 430. For this, the processor 426 may display the user interface to acquire the identification information. The processor 426 may register the identification information.

According to various example embodiments, the processor 426 may include the authentication module 427 and an authentication management module 428. The authentication module 427 and the authentication management module 428 may be implemented by being separated from each other in a hardware and/or software manner. The authentication module 427 and the authentication management module 428 may be implemented by being coupled as one module.

The authentication module 427 may perform user registration in the 2^{nd} electronic device 420. The authentication module 427 may register reference information in association with the 1^{st} electronic device 410. Alternatively, the authentication module 427 may register identification information of the user. In addition, the authentication module 427 may perform user authentication in the 2^{nd} electronic device 420. The authentication module 427 may receive authentication information from the 1^{st} electronic device 410. Accordingly, the authentication module 427 may perform authentication on authentication information on the basis of the reference information. Alternatively, the authentication module 427 may acquire the identification information of the user. Accordingly, the authentication module 427 may perform authentication on the identification information of the user on the basis of pre-stored identification information.

According to an example embodiment, the authentication module 427 may include a plurality of authentication modules. The authentication modules may be different types of modules. For example, the authentication modules may process bio information of different categories. For this, the authentication modules may correspond to different module information.

The authentication management module 428 may control a driving of the authentication module 427. The authentication management module 428 may load or unload the authentication module 427. The authentication management module 428 may determine the authentication module 427 on the basis of the module information. In addition, the authentication management module 428 may activate the authentication module 427. That is, the authentication management module 428 may load the authentication module 427 by transmitting an activation signal to the authentication module 427. Meanwhile, the authentication management module 428 may deactivate the authentication module 427. That is, the authentication management module 428 may unload the authentication module 427 by transmitting a deactivation signal to the authentication module 427.

The 3^{rd} electronic device 430 may be driven at a predetermined location. The 3^{rd} electronic device 430 may be driven under the control of the processor 426 of the 2^{nd} electronic device 420. For example, the 3^{rd} electronic device 430 may be driven by being electrically coupled to the 2^{nd} electronic device 420. Alternatively, the 3^{rd} electronic device 430 may be driven by being electrically coupled to the 2^{nd} electronic device 420. The 3^{rd} electronic device 430 may be driven by being attached to the 2^{nd} electronic device 420. According to various example embodiments, the 3^{rd} electronic device 430 may include a sensor unit 431.

The sensor unit 431 may measure physical quantity around the 3^{rd} electronic device 430. Alternatively, the sensor unit 431 may sense a state of the 3^{rd} electronic device 430. That is, the sensor unit 431 may detect a physical signal. Further, the sensor unit 431 may convert the physical signal into an electrical signal. The sensor unit 431 may include at least one sensor. For example, the sensor unit 431 may include at least any one of a gesture sensor, a gyro sensor, a pressure sensor, a magnetic sensor, an acceleration sensor, a grip sensor, a proximity sensor, a color sensor (e.g., a Red, Green, Blue (RGB) sensor), a bio sensor, a temperature/humidity sensor, an illumination sensor, and an Ultra Violet (UV) sensor. For example, the bio sensor may include at least any one of an e-nose sensor, an ElectroMyoGraphy (EMG) sensor, an ElectroEncephaloGram (EEG) sensor, an ElectroCardioGram (ECG) sensor, an Infrared (IR) sensor, an iris sensor, and a fingerprint sensor.

According to various example embodiments, an electronic device may include a display, a communication circuit, an authentication module, and a processor, wherein the processor is configured to receive an identification request for the electronic device from an external electronic device using the communication circuit, to activate the authentication module in response to the identification request, to transmit, to the external electronic device, an authentication information request for the authentication module, to receive, from the external electronic device, authentication information corresponding to a user of the external electronic device in response to the authentication information request, to perform authentication on the user on the basis of the authentication information using the authentication module, and to deactivate the authentication module if the authentication is complete.

According to various example embodiments, the processor may be configured to receive bio (e.g., biometric) information corresponding to the user of the external electronic device as at least one part of the authentication information.

According to various example embodiments, the processor may be configured to receive information generated on the basis of a result of the authentication performed in the external electronic device as at least one part of the authentication information using bio information corresponding to the user of the external electronic device.

According to various example embodiments, the processor may be configured to receive a non-bio information based passcode corresponding to the user as at least one part of the authentication information.

According to various example embodiments, the electronic device may further include an authentication management module for managing the authentication module. The authentication module may be configured to notify a notification indicating that the authentication is complete to the authentication management module.

According to various example embodiments, the processor may be configured to perform activation or deactivation of the authentication module by using the authentication management module.

According to various example embodiments, an electronic device may include a communication unit comprising communication circuitry configured to connect the electronic device with a plurality of external devices, and a processor operatively coupled to the communication unit. The processor may be configured to request the plurality of external devices for identification information, to receive the identification information from at least one of the plurality of external devices in response to the identification information request, and to cancel the request to at least one external device different from the at least one of the plurality of external devices on the basis of the reception.

According to various example embodiments, the processor may be configured to transmit an instruction configured to activate a user interface to acquire the identification information from the plurality of external devices.

According to various example embodiments, the electronic device may further include a display unit operatively coupled to the processor. The processor may be further configured to display a user interface for acquiring identification information to the display unit.

According to various example embodiments, the processor may be configured to receive the identification information from at least one of the external devices, and remove the user interface from the display unit.

According to various example embodiments, the electronic device may further include a sensor operatively coupled to the processor. The processor may be further configured to acquire the identification information via the sensor unit, and cancel the request to the external devices.

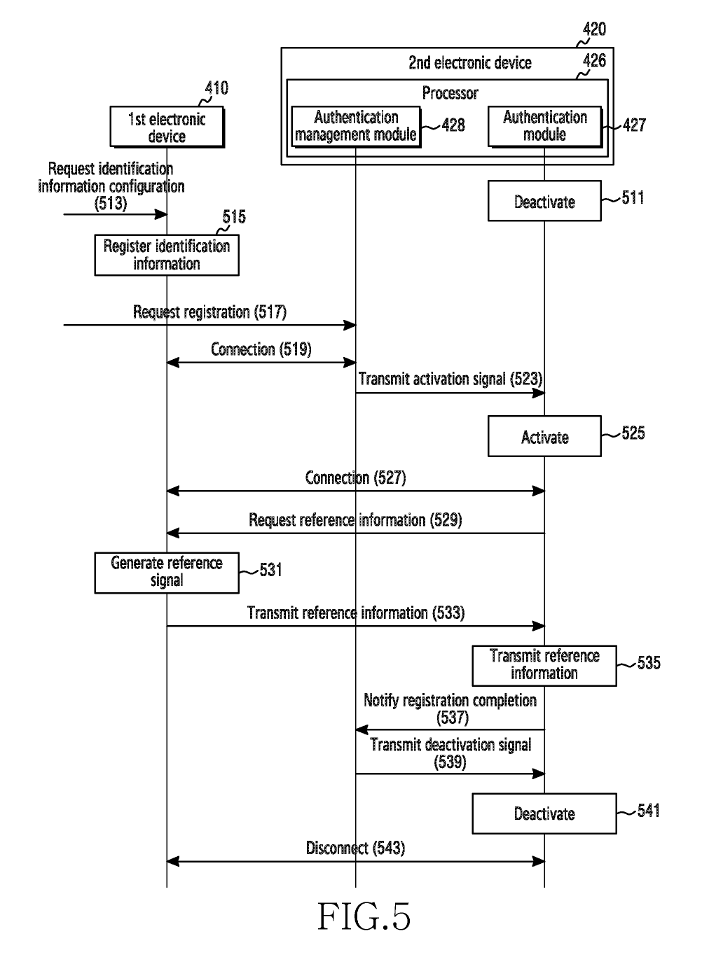

FIG. 5 is a flowchart illustrating an example method of registering bio information in the communication system 400 according to various example embodiments.

Referring to FIG. 5, the authentication module 427 of the 2^{nd} electronic device 420 may be deactivated in operation 511. A driving of the authentication module 427 may be stopped in the 2^{nd} electronic device 420. When the 2^{nd} electronic device 420 is activated, the authentication module 427 may be unloaded. That is, the authentication module 427 may be deactivated in a state where the 2^{nd} electronic device 420 is booted or wakes up.

According to various example embodiments, the 1^{st} electronic device 410 may sense a request for configuring identification information in operation 513. That is, if the request for configuring the identification information to the 1^{st} electronic device 410 is generated by a user, the 1^{st} electronic device 410 may sense this. In response thereto, the 1^{st} electronic device 410 may register the identification information in operation 515. The 1^{st} electronic device 410 may acquire the identification information from the user. In addition, the 1^{st} electronic device 410 may store the identification information in association with the user.

According to an example embodiment, the 1^{st} electronic device 410 may scan a fingerprint of the user to generate a fingerprint image. The 1^{st} electronic device 410 may extract at least one feature point from the fingerprint image. Accordingly, the 1^{st} electronic device 410 may acquire at least any one of the fingerprint image and a feature point of the fingerprint image as the identification information. Further, the 1^{st} electronic device 410 may store at least any one of the fingerprint image and the feature point of the fingerprint image as the identification information.

According to another example embodiment, the 1^{st} electronic device 410 may configure an access right to the 1^{st} electronic device 410 in association with the identification information. For example, the 1^{st} electronic device 410 may configure a right capable of unlocking the 1^{st} electronic device 410 in association with the identification information. The 1^{st} electronic device 410 may configure a right capable of executing a specific function in association with the identification information.

According various example embodiments, the authentication management module 428 of the 2^{nd} electronic device 420 may sense a registration request of the user in operation 517. That is, if a request for registering the user to the 2^{nd} electronic device 420 is generated, the authentication management module 428 of the 2^{nd} electronic device 420 may sense this. In response thereto, the authentication management module 428 of the 2^{nd} electronic device 420 may establish a connection with the 1^{st} electronic device 410 in operation 519. Accordingly, the authentication management module 428 of the 2^{nd} electronic device 420 may be connected to the 1^{st} electronic device 410. For example, the authentication management module 428 of the 2^{nd} electronic device 420 may be connected to the 1^{st} electronic device 410 by using a near-distance communication method. In addition, when connected to the 2^{nd} electronic device 420, the 1^{st} electronic device 410 may transmit module information to the 2^{nd} electronic device 420.

According to various example embodiments, the authentication management module 428 of the 2^{nd} electronic device 420 may transmit an activation signal to the authentication module 427 in operation 523. That is, the 2^{nd} electronic device 420 may transmit the activation signal to the authentication module 427 by loading the authentication module 427. Upon receiving the module information from the 1^{st} electronic device 410, the authentication management module 428 of the 2^{nd} electronic device 420 may transmit the activation signal to the authentication module 427 on the basis of the module information.

According to an example embodiment, if the authentication module 427 includes a plurality of bio sensing modules, the authentication management module 428 of the 2^{nd} electronic device 420 may select at least any one of the bio sensing modules on the basis of the module information. For example, if the module information indicates fingerprint information, the authentication management module 428 of the 2^{nd} electronic device 420 may select any one of the bio sensing modules for the fingerprint information. In addition, the authentication management module 428 of the 2^{nd} electronic device 420 may transmit the activation signal to at least any one of the bio sensing modules.

According to various example embodiments, upon receiving the activation signal from the authentication management module 428 of the 2^{nd} electronic device 420 in operation 523, the authentication module 427 of the 2^{nd} electronic device 420 may be activated in operation 525. In the 2^{nd} electronic device 420, the authentication module 427 may be driven in response to the activation signal. For example, when the 2^{nd} electronic device 420 is activated, the authentication module 427 may be activated. For another example, when the 2^{nd} electronic device 420 is activated, the authentication module 427 may be loaded in the 2^{nd} electronic device 420. In addition, the authentication module 427 of the 2^{nd} electronic device 420 may establish a connection with the 1^{st} electronic device 410 in operation 527. Accordingly, the authentication module 427 of the 2^{nd} electronic device 420 may be connected to the 1^{st} electronic device 410. For example, the authentication module 427 of the 2^{nd} electronic device 420 may be connected to the 1^{st} electronic device 410 by using a near-distance communication method. Further, the authentication module 427 of the 2^{nd} electronic device 420 may request the 1^{st} electronic device 410 for reference information in operation 529.

According to various example embodiments, if a reference information request is notified from the authentication module 427 of the 2^{nd} electronic device 420 in operation 529, the 1^{st} electronic device 410 may generate reference information in operation 531. For example, the 1^{st} electronic device 410 may perform authentication on the identification information. In addition, the 1^{st} electronic device 410 may generate the reference information on the basis of an authentication result. That is, if the authentication of the identification information is successful, the 1^{st} electronic device 410 may generate one pair of a private key and a public key.

According to various example embodiments, in operation 533, the 1^{st} electronic device 410 may transmit the reference information to the authentication module 427 of the 2^{nd} electronic device 420. For example, the 1^{st} electronic device 410 may store the private key, and may transmit the public key to the authentication module 427 of the 2^{nd} electronic device 420. The 1^{st} electronic device 410 may transmit the public key to the authentication module 427 of the 2^{nd} electronic device 420 by using a near-distance communication method.

According to various example embodiments, upon receiving the reference information from the 1^{st} electronic device 410 in operation 533, the authentication module 427 of the 2^{nd} electronic device 420 may register the reference information in operation 535. That is, the authentication module 427 of the 2^{nd} electronic device 420 may store the reference information in association with the 1^{st} electronic device 410. For example, the authentication module 427 may store the public key in association with the 1^{st} electronic device 410. According to an example embodiment, the authentication module 427 of the 2^{nd} electronic device 420 may configure an access right to the 2^{nd} electronic device 420 in association with the 1^{st} electronic device 410. For example, the authentication module 427 of the 2^{nd} electronic device 420 may configure a right capable of unlocking the 2^{nd} electronic device 420 in association with the 1^{st} electronic device 410. Alternatively, the authentication module 427 of the 2^{nd} electronic device 420 may configure a right capable of executing a specific function in association with the 1^{st} electronic device 410. In addition, in operation 537, the authentication module 427 of the 2^{nd} electronic device 420 may notify a registration completion of the reference information to the authentication management module 428.

According to various example embodiments, upon notifying the registration completion of the reference information from the authentication module 427 of the 2^{nd} electronic device 420 in operation 537, the authentication management module 428 of the 2^{nd} electronic device 420 may transmit a deactivation signal to the authentication module 427 in operation 539. That is, the authentication management module 428 of the 2^{nd} electronic device 420 may unload the authentication module 427 by transmitting the deactivation signal to the authentication module 427.

According to various example embodiments, upon receiving the deactivation signal from the authentication management module 428 of the 2^{nd} electronic device 420 in operation 539, the authentication module 427 of the 2^{nd} electronic device 420 may be deactivated in operation 541. A driving of the authentication module 427 may be stopped in the 2^{nd} electronic device 420 in response to the deactivation signal. For example, even if the 2^{nd} electronic device 420 is activated, the authentication module 427 may be deactivated. Accordingly, the authentication module 427 may be unloaded from the 2^{nd} electronic device 420. In addition, in operation 543, the authentication module 427 of the 2^{nd} electronic device 420 may be disconnected from the 1^{st} electronic device 410. For example, the authentication module 427 of the 2^{nd} electronic device 420 may stop being connected with the 1^{st} electronic device 410.

According to an example embodiment, although not shown, the authentication management module 428 of the 2^{nd} electronic device 420 may be disconnected from the 1^{st} electronic device 410. Accordingly, in the 2^{nd} electronic device 420, not only the authentication module 427 but also the authentication management module 428 may stop being connected to the 1^{st} electronic device 410.

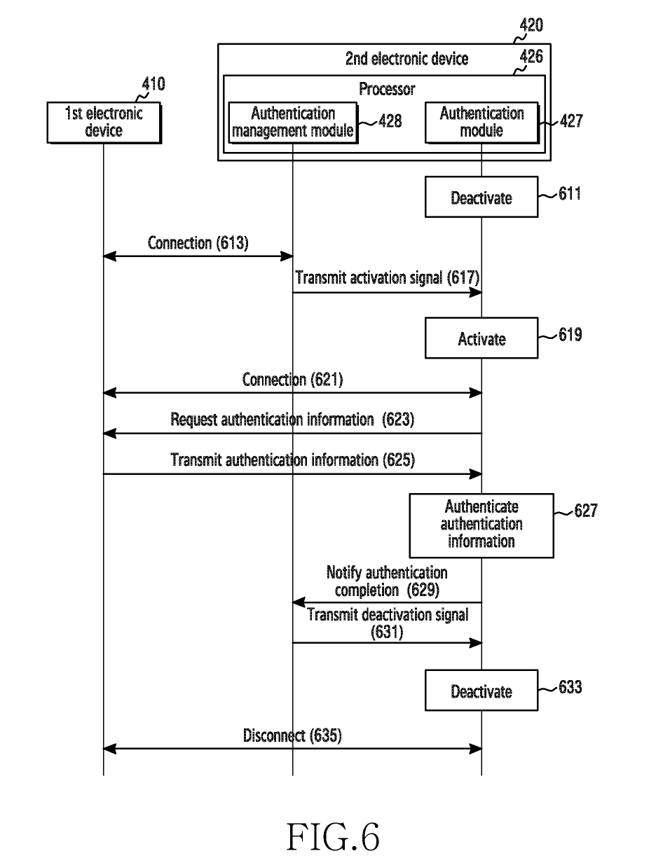

FIG. 6 is a flowchart illustrating an example method of authenticating bio information in the communication system 400 according to various example embodiments.

Referring to FIG. 6, the authentication module 427 of the 2^{nd} electronic device 420 may be deactivated in operation 611. A driving of the authentication module 427 may be stopped in the 2^{nd} electronic device 420. For example, when the 2^{nd} electronic device 420 is activated or deactivated, the authentication module 427 may be deactivated.

According to various example embodiments, the 1^{st} electronic device 410 may establish a connection with the authentication management module 428 of the 2^{nd} electronic device 420 in operation 613. For example, a request for connection with the 2^{nd} electronic device 420 may be generated in the 1^{st} electronic device 410 by a user of the 1^{st} electronic device 410. The 2^{nd} electronic device 420 may request the connection to the 1^{st} electronic device 410 if the 2^{nd} electronic device 420 is activated. In response thereto, the 1^{st} electronic device 410 may establish a connection with the authentication management module 428 of the 2^{nd} electronic device 420. For example, the 1^{st} electronic device 410 may be connected with the authentication management module 428 of the 2^{nd} electronic device 420 by using a near-distance communication method. In addition, the 1^{st} electronic device 410 may transmit module information to the 2^{nd} electronic device 420.

According to various example embodiments, the authentication management module 428 of the 2^{nd} electronic device 420 may transmit an activation signal to the authentication module 427 in operation 617. That is, the 2^{nd} electronic device 420 may transmit the activation signal to the authentication module 427 by loading the authentication module 427. The authentication management module 428 of the 2^{nd} electronic device 420 may load the authentication module 427 by transmitting an activation signal to the authentication module 427.

According to an example embodiment, if the authentication module 427 includes a plurality of bio sensing modules, the authentication management module 428 of the 2^{nd} electronic device 420 may select at least any one of the bio sensing modules on the basis of the module information. For example, if the module information indicates fingerprint information, the authentication management module 428 of the 2^{nd} electronic device 420 may select any one of the bio sensing modules for the fingerprint information. In addition, the authentication management module 428 of the 2^{nd} electronic device 420 may transmit the activation signal to at least any one of the bio sensing modules.

According to various example embodiments, upon receiving the activation signal from the authentication management module 428 of the 2^{nd} electronic device 420 in operation 617, the authentication module 427 of the 2^{nd} electronic device 420 may be activated in operation 619. In the 2^{nd} electronic device 420, the authentication module 427 may be driven in response to the activation signal. For example, when the 2^{nd} electronic device 420 is activated, the authentication module 427 may be activated. Accordingly, the authentication module 427 may be loaded in the 2^{nd} electronic device 420. In addition, the authentication module 427 of the 2^{nd} electronic device 420 may establish a connection with the 1^{st} electronic device 410 in operation 621. Accordingly, the authentication module 427 of the 2^{nd} electronic device 420 may be connected to the 1^{st} electronic device 410. For example, the authentication module 427 of the 2^{nd} electronic device 420 may be connected to the 1^{st} electronic device 410 by using a near-distance communication method. Further, the authentication module 427 of the 2^{nd} electronic device 420 may request the 1^{st} electronic device 410 for authentication information in operation 623. For example, the authentication module 427 may generate random data, and may encrypt random data by using a public key to generate encryption data. Further, the authentication module 427 may transmit the encryption data to the 1^{st} electronic device 410.

According to various example embodiments, if the authentication information is requested from the authentication module 427 of the 2^{nd} electronic device 420 in operation 623, the 1^{st} electronic device 410 may transmit the authentication information to the authentication module 427 of the 2^{nd} electronic device 420 in operation 625. For example, the 1^{st} electronic device 410 may decode the encryption data by using a private key and thus may acquire random data. In addition, the 1^{st} electronic device 410 may perform authentication on identification information of the user. Further, the 1^{st} electronic device 410 may generate authentication information on the basis of an authentication result. That is, if the authentication of the identification information is successful, the 1^{st} electronic device 410 may generate the authentication information on the basis of the private key and the random data. That is, the 1^{st} electronic device 410 may encrypt the random data by using the private key to generate the authentication information. Accordingly, the 1^{st} electronic device 410 may transmit the authentication information to the 2^{nd} electronic device 420.

According to various example embodiments, upon receiving the authentication information from the 1^{st} electronic device 410 in operation 625, the authentication module 427 of the 2^{nd} electronic device 420 may perform authentication of the authentication information in operation 627. For example, the authentication module 427 of the 2^{nd} electronic device 420 may decode the authentication information by using a public key to acquire random data. In addition, the authentication module 427 may determine whether the random data is changed. If the random data is not changed but identical, the authentication module 427 of the 2^{nd} electronic device 420 may determine that the authentication of the authentication information is successful. Alternatively, if the random data is changed, the authentication module 427 of the 2^{nd} electronic device 420 may determine that the authentication of the authentication information has failed. In addition, the authentication module 427 of the 2^{nd} electronic device 420 may notify to the authentication management module 428 that the authentication of the authentication information is complete.

According to various example embodiments, if it is notified from the authentication module 427 that the authentication of the authentication information is complete in operation 629, the authentication management module 428 of the 2^{nd} electronic device 420 may transmit a deactivation signal to the authentication module 427. That is, the authentication management module 428 of the 2^{nd} electronic device 420 may transmit the deactivation signal to the authentication module 427 to deactivate the authentication module 427.

According to various example embodiments, upon receiving the deactivation signal from the authentication management module 428 of the 2^{nd} electronic device 420 in operation 631, the authentication module 427 of the 2^{nd} electronic device 420 may be deactivated in operation 633. The 2^{nd} electronic device 420 may stop a driving of the authentication module 427 in response to the deactivation signal. For example, even if the 2^{nd} electronic device 420 is activated, the authentication module 427 may be deactivated. Accordingly, the authentication module 427 may be unloaded from the 2^{nd} electronic device 420. In addition, the authentication module 427 of the 2^{nd} electronic device 420 may be disconnected from the 1^{st} electronic device 410 in operation 635. For example, the authentication module 427 of the 2^{nd} electronic device 420 may stop being connected with the 1^{st} electronic device 410.

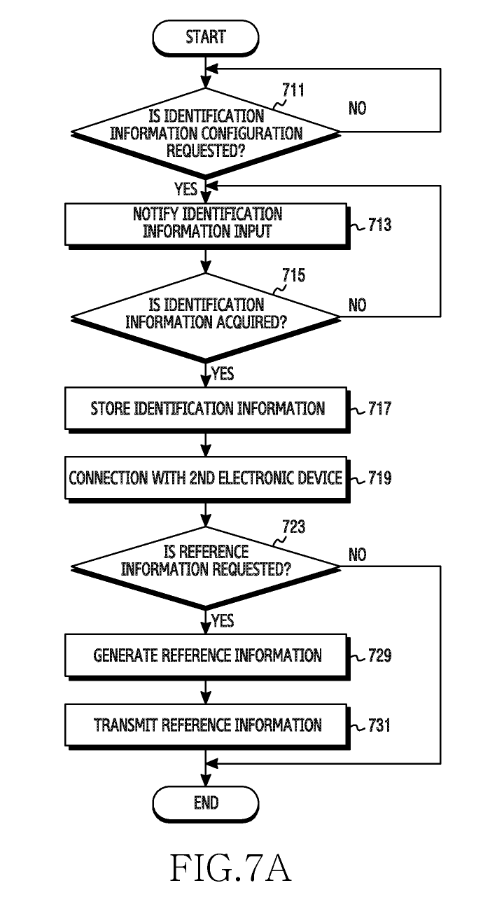

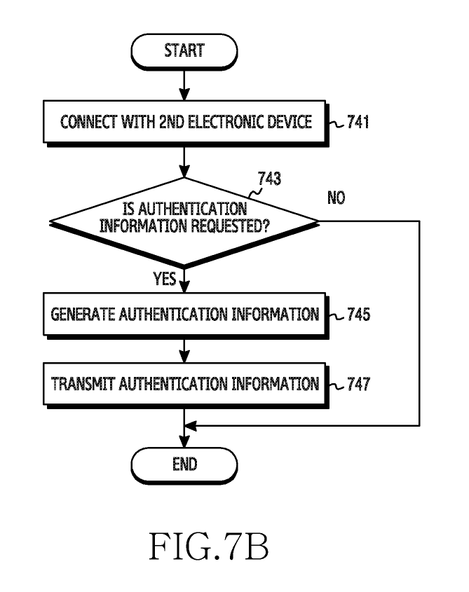

FIG. 7A is a flowchart illustrating an example method of operating the 1^{st} electronic device 410 according to various example embodiments.

Referring to FIG. 7A, the processor 416 may sense a request for configuring identification information in operation 711. That is, if the request for configuring the identification information to the 1^{st} electronic device 410 is generated by a user, the processor 416 may sense this. For example, the processor 416 may sense the request for configuring the identification information via the input unit 412 or the sensor unit 414.

In operation 713, the processor 416 may notify an input of the identification information to the user. The processor 416 may notify to the user that the identification information is input, by using display data or audio data. For example, the processor 416 may output a user interface for the input of the identification information via the display unit 413.

The processor 416 may acquire the identification information of the user in operation 715. For example, the processor 416 may temporarily activate a bio sensor of the sensor unit 414. The bio sensor may include at least any one of an e-nose sensor, an ElectroMyoGraphy (EMG) sensor, an ElectroEncephaloGram (EEG) sensor, an ElectroCardioGram (ECG) sensor, an Infrared (IR) sensor, an iris sensor, and a fingerprint sensor. In addition, the processor 416 may acquire the identification information by using the bio sensor. According to an example embodiment, the processor 416 may scan a fingerprint of the user to generate a fingerprint image. The processor 416 may extract at least one feature point from the fingerprint image. Accordingly, the processor 416 may acquire at least any one of the fingerprint image and a feature point of the fingerprint image as the identification information.

The processor 416 may store the identification information in association with the user in operation 717. For example, the processor 416 may store at least any one of the fingerprint image and a feature point of the fingerprint image as the identification information in the memory 415. For example, the processor 416 may configure an access right to the 1^{st} electronic device 410 in association with the identification information. According to an example embodiment, the processor 416 may configure a right capable of unlocking the 1^{st} electronic device 410 in association with the identification information. The processor 416 may configure a right capable of executing a specific function in association with the identification information.

The processor 416 may establish a connection with the 2^{nd} electronic device 420 in operation 719. For example, the processor 416 may establish a connection with the 2^{nd} electronic device 420 using a near-distance communication method. The processor 416 may transmit a connection request to the 2^{nd} electronic device 420. In addition, the processor 416 may receive a connection response of the 2^{nd} electronic device 420. Accordingly, if the connection response of the 2^{nd} electronic device 420 is positive, the processor 416 may complete the connection with the 2^{nd} electronic device 420. Further, the processor 416 may establish the connection with the 2^{nd} electronic device 420 on the basis of a user's selection. According to an example embodiment, the processor 416 may search for a neighboring device. When the 2^{nd} electronic device 420 is found in this manner, the processor 416 may establish the connection with the 2^{nd} electronic device 420. Further, the processor 416 may establish the connection with the 2^{nd} electronic device 420 on the basis of the user's selection. In this case, the processor 416 may transmit module information to the 2^{nd} electronic device 420.

If reference information is requested from the 2^{nd} electronic device 420, the processor 416 may sense this in operation 723. In response thereto, the processor 416 may generate the reference information in operation 729. For example, the processor 416 may perform authentication on the identification information. In addition, the processor 416 may generate the reference information on the basis of an authentication result. That is, if the authentication of the identification information is successful, the processor 416 may generate one pair of a private key and a public key. The processor 416 may transmit the reference information to the 2^{nd} electronic device 420 in operation 731. For example, the processor 416 may store the private key, and may transmit the public key to the 2^{nd} electronic device 420.

FIG. 7B is a flowchart illustrating an example method of operating the 1^{st} electronic device 410 according to various example embodiments.

Referring to FIG. 7B, the processor 416 may establish a connection with the 2^{nd} electronic device 420 in operation 741. For example, the processor 416 may establish a connection with the 2^{nd} electronic device 420 using a near-distance communication method. The processor 416 may transmit a connection request to the 2^{nd} electronic device 420. In addition, the processor 416 may receive a connection response of the 2^{nd} electronic device 420. Accordingly, if the connection response of the 2^{nd} electronic device 420 is positive, the processor 416 may complete the connection with the 2^{nd} electronic device 420. Further, the processor 416 may establish the connection with the 2^{nd} electronic device 420 on the basis of a user's selection. According to an example embodiment, the processor 416 may search for a neighboring device. When the 2^{nd} electronic device 420 is found in this manner, the processor 416 may establish the connection with the 2^{nd} electronic device 420. Further, the processor 416 may establish the connection with the 2^{nd} electronic device 420 on the basis of the user's selection. In this case, the processor 416 may transmit module information to the 2^{nd} electronic device 420.

If authentication information is requested from the 2^{nd} electronic device 420, the processor 416 may sense this in operation 743. In this case, the processor 416 may receive encryption data from the 2^{nd} electronic device 420. In response thereto, the processor 416 may generate the authentication information in operation 745. For example, the processor 416 may decode the encryption data by using a private key and thus may acquire random data. In addition, the processor 416 may perform authentication on identification information of the user. Further, the processor 416 may generate authentication information on the basis of an authentication result. That is, if the authentication of the identification information is successful, the processor 416 may generate the authentication information on the basis of the private key and the random data. That is, the processor 416 may encrypt the random data by using the private key to generate the authentication information. In addition, the processor 416 may transmit the authentication information to the 2^{nd} electronic device 420 in operation 747.

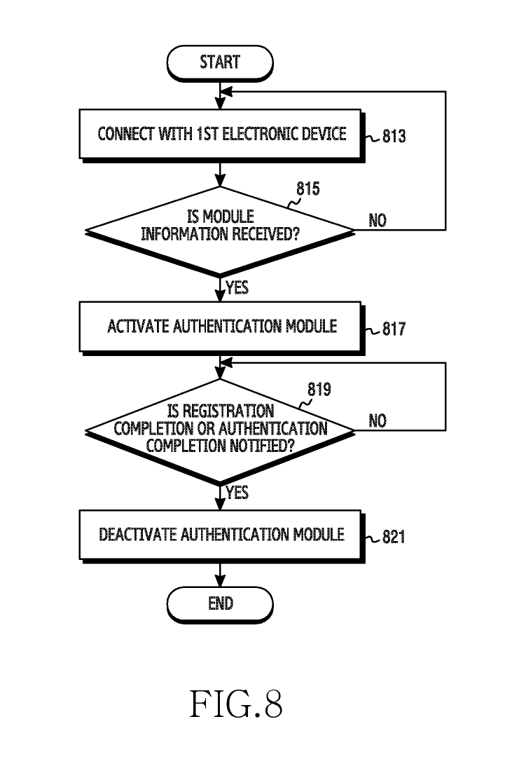

FIG. 8 illustrates a flowchart of a method of operating the 2^{nd} electronic device 420 according to various example embodiments. Specifically, FIG. 8 is a flowchart illustrating an example method of operating the authentication management module 428 of the 2^{nd} electronic device 420.

Referring to FIG. 8, the authentication management module 428 may establish a connection with the 1^{st} electronic device 410 in operation 813. The authentication management module 428 may establish the connection with the first electronic device 410 via the communication unit 421. For example, the authentication management module 428 may establish the connection with the 1^{st} electronic device 410 using a near-distance communication method. Upon receiving a connection request from the 1^{st} electronic device 410, the authentication management module 428 may determine whether to be connected with the 1^{st} electronic device 410. In addition, the authentication management module 428 may transmit a connection response regarding whether to be connected to the 1^{st} electronic device 410. Accordingly, if the connection response is positive, the authentication management module 428 may complete the connection with the 1^{st} electronic device 410. In this case, the authentication management module 428 may sense whether the module information is received from the 1^{st} electronic device 410 in operation 815.

According to various example embodiments, the authentication management module 428 may activate the authentication module 427 in operation 817. That is, the authentication management module 428 may load the authentication module 427. For this, the authentication management module 428 may transmit an activation signal to the authentication module 427. The authentication management module 428 may transmit the activation signal to the authentication module 427 on the basis of the module information.

According to an example embodiment, if the authentication module 427 includes a plurality of bio sensing modules, the authentication management module 428 may select at least any one of the bio sensing modules on the basis of the module information. For example, if the module information indicates fingerprint information, the authentication management module 428 may select any one of the bio sensing modules for the fingerprint information. In addition, the authentication management module 428 may transmit the activation signal to at least any one of the bio sensing modules.

If it is notified from the authentication module 427 that 2^{nd} bio information is completely registered or authenticated, the authentication management module 428 may sense this in operation 819. In addition, the authentication management module 428 may deactivate the authentication module 427 in operation 821. That is, the authentication management module 428 may unload the authentication module 427. For this, the authentication management module 428 may transmit a deactivation signal to the authentication module 427.

According to an example embodiment, although not shown, the authentication management module 428 may deactivate the authentication module 427 and thereafter may be disconnected from the 1^{st} electronic device 410. Accordingly, in the 2^{nd} electronic device 420, not only the authentication module 427 but also the authentication management module 428 may stop being connected to the 1^{st} electronic device 410.

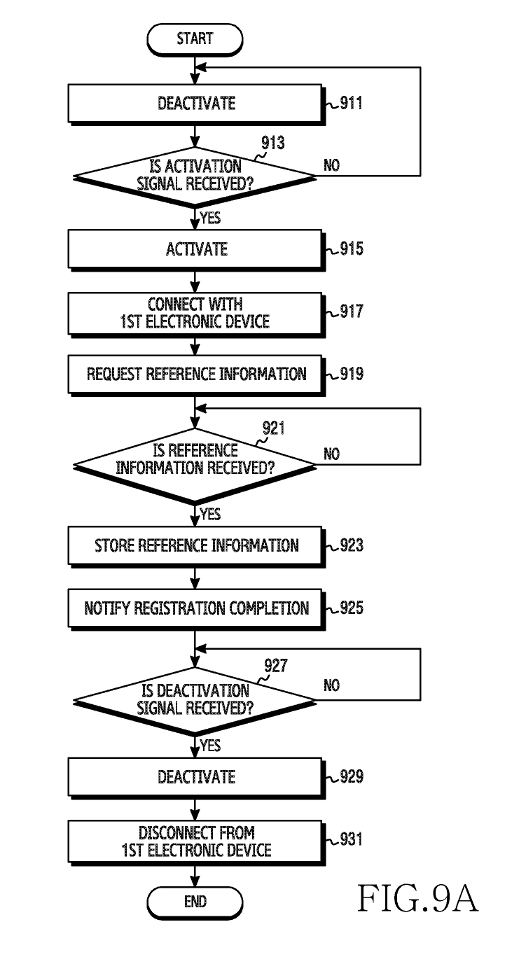

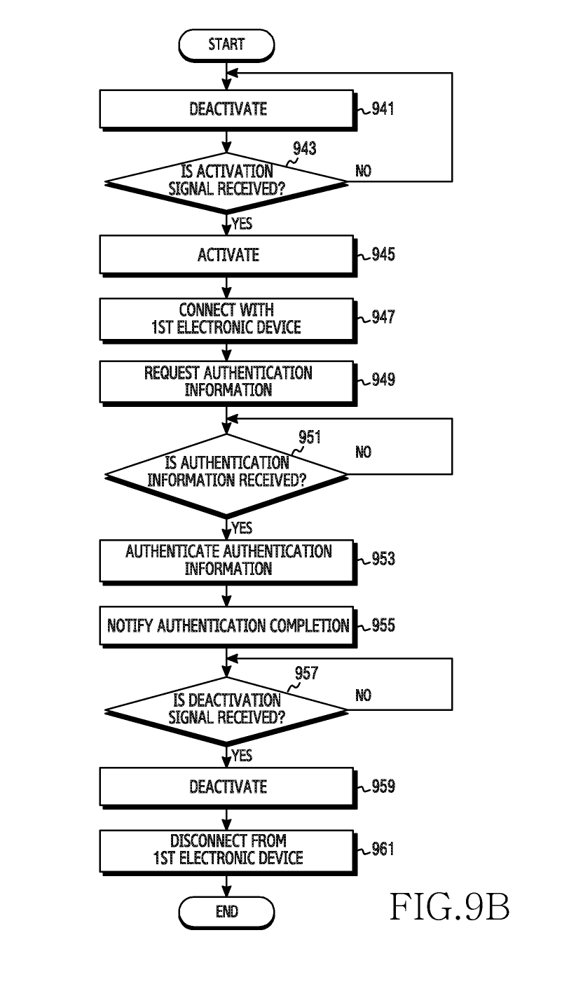

FIG. 9A is a flowchart illustrating an example method of operating the 2^{nd} electronic device 420 according to various example embodiments. Specifically, FIG. 9A illustrates a flowchart of a method of operating the authentication module 427 in the 2^{nd} electronic device 420.

Referring to FIG. 9A, the authentication module 427 of the 2^{nd} electronic device 420 may be deactivated in operation 911. A driving of the authentication module 427 may be stopped. For example, when the 2^{nd} electronic device 420 is activated, the authentication module 427 may be deactivated.

Upon receiving the activation signal from the authentication management module 428, the authentication module 427 may sense this in operation 913. In addition, the authentication module 427 may be activated in response to the activation signal in operation 915. The authentication module 427 may be driven. For example, when the 2^{nd} electronic device 420 is activated, the authentication module 427 may be activated. Accordingly, the authentication module 427 may be loaded under the control of the processor 426

In operation 917, the authentication module 427 may establish a connection with the 1^{st} electronic device 410. The authentication module 427 may establish the connection with the 1^{st} electronic device 410 via the communication unit 421. That is, the authentication module 427 may be electrically connected to the communication unit 421 so as to be connected to the 1^{st} electronic device 410. For example, the authentication module 427 may be connected to the 1^{st} electronic device 410 by using a near-distance communication method. In addition, in operation 919, the authentication module 427 may request the 1^{st} electronic device 410 for reference information.

Upon receiving the reference information from the 1^{st} electronic device 410, the authentication module 427 may sense this in operation 921. In addition, the authentication module 427 may store the reference information in operation 923. That is, the authentication module 427 may store the reference information in association with the 1^{st} electronic device 410 in operation 923. For example, the reference information may be a public key. According to an example embodiment, the authentication module 427 may configure an access right to the 2^{nd} electronic device 420 in association with the 1^{st} electronic device 410. For example, the authentication module 427 may configure a right capable of unlocking the 2^{nd} electronic device 420 in association with the 1^{st} electronic device 410. The authentication module 427 may configure a right capable of executing a specific function in association with the 1^{st} electronic device 410. In addition, in operation 925, the authentication module 427 may notify to the authentication management module 428 that the reference information is completely registered.

Upon receiving a deactivation signal from the authentication management module 428, the authentication module 427 may sense this in operation 927. In addition, in operation 929, the authentication module 427 may be deactivated in response to the deactivation signal. In other words, the authentication module 427 may stop being driven in response to the deactivation signal. For example, even if the 2^{nd} electronic device 420 is activated, the authentication module 427 may be deactivated. Accordingly, the authentication module 427 may be unloaded under the control of the authentication management module 428. In addition, in operation 931, the authentication module 427 may be disconnected from the 1^{st} electronic device 410. For example, the authentication module 427 may stop being connected with the 1^{st} electronic device 410.

FIG. 9B is a flowchart illustrating an example method of operating the 2^{nd} electronic device 420 according to various example embodiments. Specifically, FIG. 9B is a flowchart illustrating an example method of operating the authentication module 427 in the 2^{nd} electronic device 420.

Referring to FIG. 9B, the authentication module 427 of the 2^{nd} electronic device 420 may be deactivated in operation 941. A driving of the authentication module 427 may be stopped. For example, when the 2^{nd} electronic device 420 is activated, the authentication module 427 may be deactivated.

Upon receiving the activation signal from the authentication management module 428, the authentication module 427 may sense this in operation 943. In addition, the authentication module 427 may be activated in response to the activation signal in operation 945. That is, the authentication module 427 may be driven in response to the activation signal. For example, when the 2^{nd} electronic device 420 is activated, the authentication module 427 may be activated. Accordingly, the authentication module 427 may be loaded under the control of the processor 426.

In operation 947, the authentication module 427 may establish a connection with the 1^{st} electronic device 410. The authentication module 427 may establish the connection with the 1^{st} electronic device 410 via the communication unit 421. That is, the authentication module 427 may be electrically connected to the communication unit 421 so as to be connected to the 1^{st} electronic device 410. For example, the authentication module 427 may be connected to the 1^{st} electronic device 410 by using a near-distance communication method. In addition, in operation 949, the authentication module 427 may request the 1^{st} electronic device 410 for reference information. For example, the authentication module 427 may generate random data, and may encrypt random data by using a public key to generate encryption data. Further, the authentication module 427 may transmit the encryption data to the 1^{st} electronic device 410.

Upon receiving the authentication information from the 1^{st} electronic device 410, the authentication module 427 may sense this in operation 951. In addition, the authentication module 427 may perform authentication on the authentication information in operation 953. For example, the authentication module 427 of the 2^{nd} electronic device 420 may decode the authentication information by using a public key to acquire random data. In addition, the authentication module 427 may determine whether the random data is changed. If the random data is not changed but identical, the authentication module 427 of the 2^{nd} electronic device 420 may determine that the authentication of the authentication information is successful. If the random data is changed, the authentication module 427 of the 2^{nd} electronic device 420 may determine that the authentication of the authentication information has failed. In addition, the authentication module 427 may notify to the authentication management module 428 that the authentication of the authentication information is complete.

Upon receiving a deactivation signal from the authentication management module 428, the authentication module 427 may sense this in operation 957. In addition, in operation 959, the authentication module 427 may be deactivated in response to the deactivation signal. The authentication module 427 may stop being driven. For example, even if the 2^{nd} electronic device 420 is activated, the authentication module 427 may be deactivated. Accordingly, the authentication module 427 may be unloaded under the control of the authentication management module 428. In addition, in operation 961, the authentication module 427 may be disconnected from the 1^{st} electronic device 410. For example, the authentication module 427 may stop being connected with the 1^{st} electronic device 410.

According to various example embodiments, a method of operating an electronic device may include receiving an access request for the electronic device from an external electronic device, activating the authentication module in response to the access request, transmitting, to the external electronic device, an authentication information request for the authentication module, receiving, from the external electronic device, authentication information corresponding to a user of the external electronic device in response to the authentication information request, performing authentication on the user on the basis of the authentication information by using the authentication module, and deactivating the authentication module if the authentication is complete.

According to various example embodiments, in the receiving of the authentication information, bio information corresponding to the user of the external electronic device may be received as at least one part of the authentication information.

According to various example embodiments, in the receiving of the authentication information, information generated on the basis of a result of the authentication performed in the external electronic device as at least one part of the authentication information may be received by using bio information corresponding to the user of the external electronic device.

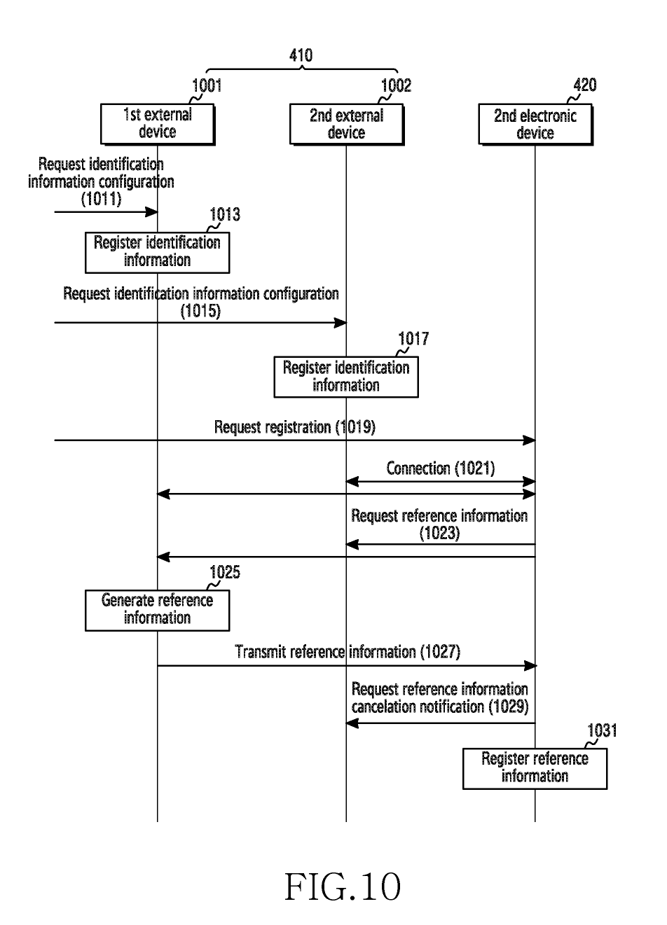

FIG. 10 is a flowchart illustrating an example method of registering bio information in the communication system 400 according to various example embodiments. According to various example embodiments, the communication system 400 may include the plurality of 1^{st} electronic devices 410 and the 2^{nd} electronic device 420. Any one of the 1^{st} electronic devices 410 may be a 1^{st} external device 1001 of the 2^{nd} electronic device 420, and another one of the 1^{st} electronic devices 410 may be a 2^{nd} external device 1002 of the 2^{nd} electronic device 420.

Referring to FIG. 10, the 1^{st} external device 1001 may sense a request for configuring identification information in operation 1011. That is, if the request for configuring the identification information is generated in the 1^{st} external device 1001 by a user, the 1^{st} external device 1001 may sense this. In response thereto, the 1^{st} external device 1001 may register the identification information in operation 1013. The 1^{st} external device 1001 may acquire the identification information from the user. In addition, the 1^{st} external device 1001 may store the identification information in association with the user.

According to various example embodiments, the 2^{nd} external device 1002 may sense the request for configuring the identification information in operation 1015. That is, if the request for configuring the identification information is generated in the 2^{nd} external device 1002 by the user, the 2^{nd} external device 1002 may sense this. In response thereto, the 2^{nd} external device 1002 may register the identification information in operation 1017. The 2^{nd} external device 1002 may acquire the identification information from the user. In addition, the 2^{nd} external device 1002 may store the identification information in association with the user.

According to an example embodiment, a user of the 1^{st} external device 1001 and a user of the 2^{nd} external device 1002 may be the same or different from each other. For example, one user may register identification information to each of the 1^{st} external device 1001 and the 2^{nd} external device 1002. Alternatively, two users may register identification information respectively to the 1^{st} external device 1001 and the 2^{nd} external device 1002.

According to another example embodiment, a category of identification information of the 1^{st} external device 1001 and a category of identification information of the 2^{nd} external device 1002 may be the same or different. For example, both of the identification information of the 1^{st} external device 1001 and the identification information of the 2^{nd} external device 1002 may correspond to fingerprint information. Alternatively, the identification information of the 1^{st} external device 1001 may correspond to fingerprint information, and 2^{nd} bio information of the 2^{nd} external device 1002 may correspond to iris information.

According to various example embodiments, the 2^{nd} electronic device 420 may sense a request for configuring the user in operation 1019. That is, if the request for configuring the user to the 2^{nd} electronic device 420 is generated, the 2^{nd} electronic device 420 may sense this. In response thereto, in operation 1021, the 2^{nd} electronic device 420 may establish a connection with the 1^{st} external device 1001 and the 2^{nd} external device 1002. Accordingly, the 2^{nd} electronic device 420 may be connected to the 1^{st} external device 1001, and the 2^{nd} electronic device 420 may be connected to the 2^{nd} external device 1002. For example, the 2^{nd} electronic device 420 may be connected with the 1^{st} external device 1001 and the 2^{nd} external device 1002 by using a near-distance communication method. In addition, in operation 1023, the 2^{nd} electronic device 420 may request the 1^{st} external device 1001 and the 2^{nd} external device 1002 for reference information.

According to various example embodiments, if reference information is requested from the 2^{nd} electronic device 420 in operation 1023, the 1^{st} external device 1001 may generate the reference information in operation 1025. In this case, the 1^{st} external device 1001 may generate one pair of a private key and a public key. In addition, the 1^{st} external device 1001 may transmit the reference information to the 2^{nd} electronic device 420 in operation 1027. In this case, the 1^{st} external device 1001 may store the private key, and may transmit the public key to the 2^{nd} electronic device 420.

According to various example embodiments, upon receiving the reference information from the 1^{st} external device 1001 in operation 1027, the 2^{nd} electronic device 420 may notify to the 2^{nd} external device 1002 that the request of the reference information is canceled in operation 1029. In addition, the 2^{nd} electronic device 420 may register the reference information in operation 1031. That is, the 2^{nd} electronic device 420 may store the reference information in association with the 1^{st} external device 1001.

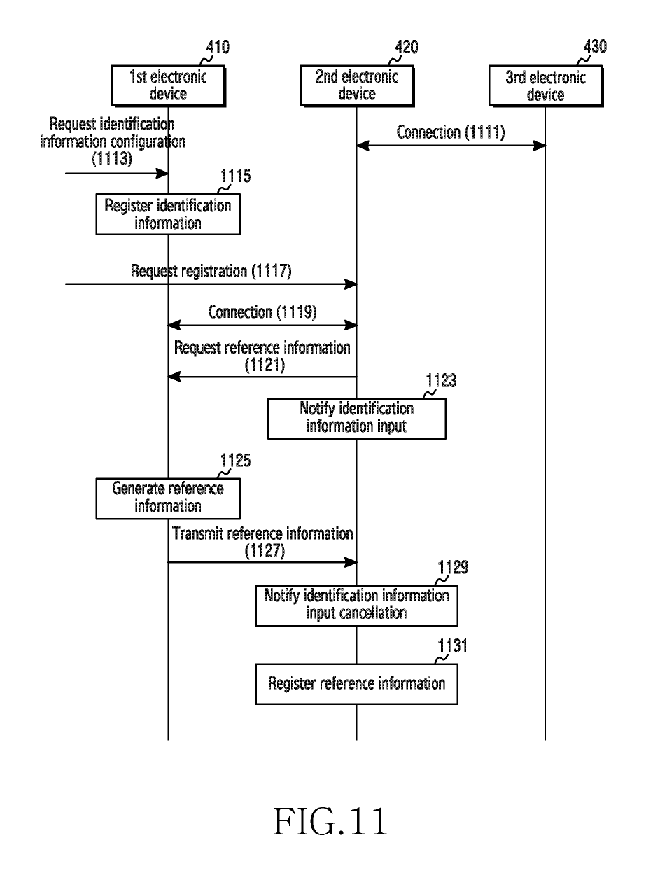

FIG. 11 is a flowchart illustrating an example method of registering bio information in the communication system 400 according to various example embodiments.

Referring to FIG. 11, the 2^{nd} electronic device 420 and the 3^{rd} electronic device 430 may be connected in operation 1111. For example, the 3^{rd} electronic device 320 may be electrically connected to the 2^{nd} electronic device 420. Alternatively, the 3^{rd} electronic device 430 may be electrically connected to the 2^{nd} electronic device 420. Alternatively, the 3^{rd} electronic device 430 may be attached to the 2^{nd} electronic device 420.

According to various example embodiments, the 1^{st} electronic device 410 may sense a request for configuring identification information in operation 1113. That is, if the request for configuring the identification information to the 1^{st} electronic device 410 is generated by a user, the 1^{st} electronic device 410 may sense this. In response thereto, the 1^{st} electronic device 410 may register the identification information in operation 1115. The 1^{st} electronic device 410 may acquire the identification information from the user. In addition, the 1^{st} electronic device 410 may store the identification information in association with the user.

According to various example embodiments, in operation 1117, the 2^{nd} electronic device 420 may sense a request for registering the user. That is, if the request for configuring the user to the 2^{nd} electronic device 420 is generated by the user, the 2^{nd} electronic device 420 may sense this. In response thereto, in operation 1119, the processor 426 of the 2^{nd} electronic device 420 may establish a connection with the 1^{st} electronic device 410. Accordingly, the 2^{nd} electronic device 420 may be connected to the 1^{st} electronic device 410. For example, the 2^{nd} electronic device 420 and the 1^{st} electronic device 410 may be connected by using a near-distance communication method.

According to various example embodiments, in operation 1121, the 2^{nd} electronic device 420 may request the reference information to the 1^{st} electronic device 410. In addition, in operation 1123, the 2^{nd} electronic device 420 may notify an input of the identification information to the user.

According to various example embodiments, if reference information is requested from the 2^{nd} electronic device 420 in operation 1121, the 1^{st} electronic device 410 may generate the reference information in operation 1125. In this case, the 1^{st} electronic device 410 may generate one pair of a private key and a public key. In addition, the 1^{st} electronic device 410 may transmit the reference information to the 2^{nd} electronic device 420 in operation 1127. For example, the 1^{st} electronic device 410 may store the private key, and may transmit the public key to the 2^{nd} electronic device 420.

According to various example embodiments, upon receiving the reference information from the 1^{st} electronic device 410 in operation 1127, the 2^{nd} electronic device 420 may notify to the 2^{nd} electronic device 1102 that an input of the identification information is canceled in operation 1129. In addition, the 2^{nd} electronic device 420 may register the reference information in operation 1131. That is, the 2^{nd} electronic device 420 may store the reference information in association with the 1^{st} electronic device 410.

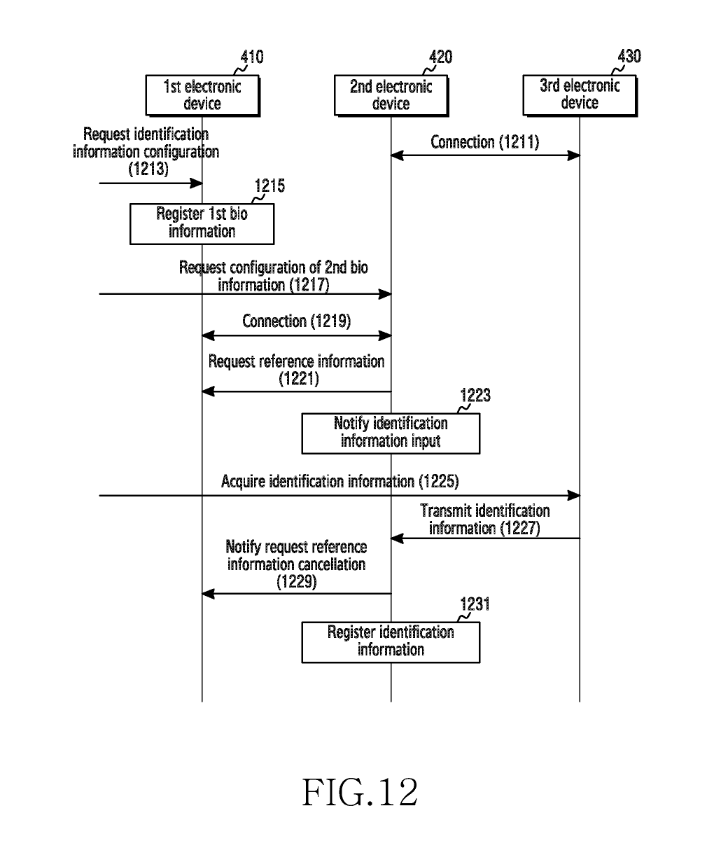

FIG. 12 is a flowchart illustrating an example method of registering bio information in the communication system 400 according to various example embodiments.

Referring to FIG. 12, the 2^{nd} electronic device 420 and the 3^{rd} electronic device 430 may be connected in operation 1211. For example, the 3^{rd} electronic device 320 may be electrically connected to the 2^{nd} electronic device 420. Alternatively, the 3^{rd} electronic device 430 may be electrically connected to the 2^{nd} electronic device 420. Alternatively, the 3^{rd} electronic device 430 may be attached to the 2^{nd} electronic device 420.

According to various example embodiments, the 1^{st} electronic device 410 may sense a request for configuring identification information in operation 1213. That is, if the request for configuring the identification information to the 1^{st} electronic device 410 is generated by a user, the 1^{st} electronic device 410 may sense this. In response thereto, the 1^{st} electronic device 410 may register the identification information in operation 1215. The 1^{st} electronic device 410 may acquire the identification information from the user. In addition, the 1^{st} electronic device 410 may store the identification information in association with the user.

According to various example embodiments, in operation 1217, the 2^{nd} electronic device 420 may sense a request for configuring 2^{nd} bio information. That is, if the request for configuring the 2^{nd} bio information to the 2^{nd} electronic device 420 is generated by the user, the 2^{nd} electronic device 420 may sense this. In response thereto, in operation 1219, the processor 426 of the 2^{nd} electronic device 420 may establish a connection with the 1^{st} electronic device 410. Accordingly, the 2^{nd} electronic device 420 may be connected to the 1^{st} electronic device 410. For example, the 2^{nd} electronic device 420 and the 1^{st} electronic device 410 may be connected by using a near-distance communication method.

According to various example embodiments, in operation 1221, the 2^{nd} electronic device 420 may request the 1^{st} electronic device 410 to input the reference information. In addition, in operation 1223, the 2^{nd} electronic device 420 may notify an input of the identification information to the user.

According to various example embodiments, in operation 1225, the 3^{rd} electronic device 430 may acquire identification information from the user. That is, if the input of the identification information is notified from the 2^{nd} electronic device 420 in operation 1223, the user may input the identification information via the 3^{rd} electronic device 430. Accordingly, the 3^{rd} electronic device 430 may acquire the identification information by using the bio sensor. In addition, in operation 1227, the 3rd electronic device 430 may transmit the identification information to the 2^{nd} electronic device 420.

According to various example embodiments, upon receiving the identification information from the 3rd electronic device 430 in operation 1227, the 2nd electronic device 420 may notify to the 1st electronic device 410 that the request of the reference information is canceled in operation 1229. In addition, the 2nd electronic device 420 may register the identification information in operation 1231. That is, the 2^{nd} electronic device 420 may store the identification information in association with the user.

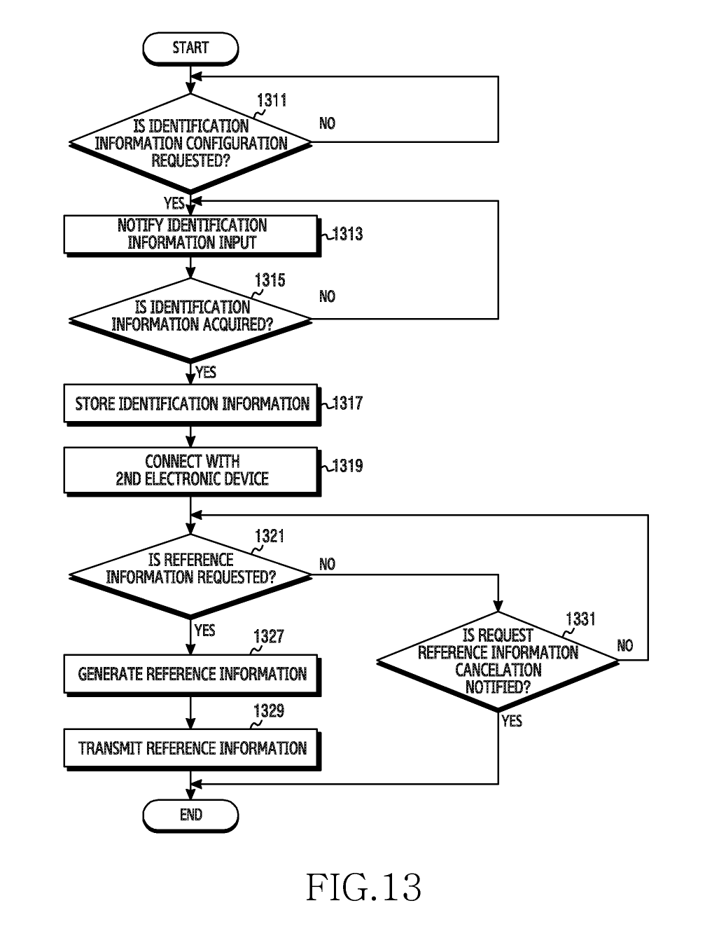

FIG. 13 is a flowchart of a method of operating the 1^{st} electronic device 410 according to various example embodiments.

Referring to FIG. 13, the processor 416 may sense a request for configuring identification information in operation 1311. That is, if the request for configuring the identification information to the 1^{st} electronic device 410 is generated by a user, the processor 416 may sense this. For example, the processor 416 may sense the request for configuring the identification information via the input unit 412 or the sensor unit 414.

In operation 1313, the processor 416 may notify an input of the identification information to the user. The processor 416 may notify to the user that the identification information is input, by using display data or audio data. For example, the processor 416 may output a user interface for the input of the identification information via the display unit 413.

The processor 416 may acquire the identification information of the user in operation 1315. For this, the processor 416 may temporarily turn on a bio sensor of the sensor unit 414. For example, the bio sensor may include at least any one of an e-nose sensor, an ElectroMyoGraphy (EMG) sensor, an ElectroEncephaloGram (EEG) sensor, an ElectroCardioGram (ECG) sensor, an Infrared (IR) sensor, an iris sensor, and a fingerprint sensor. In addition, the processor 416 may acquire the identification information by using the bio sensor. According to an example embodiment, the processor 416 may scan a fingerprint of the user to generate a fingerprint image. Alternatively, the processor 416 may extract at least one feature point from the fingerprint image. Accordingly, the processor 416 may acquire at least any one of the fingerprint image and a feature point of the fingerprint image as the identification information.

The processor 416 may store the identification information in association with the user in operation 1317. For example, the processor 416 may store at least any one of the fingerprint image and a feature point of the fingerprint image as the identification information in the memory 415. For example, the processor 416 may configure an access right to the 1^{st} electronic device 410 in association with the identification information. According to an example embodiment, the processor 416 may configure a right capable of unlocking the 1^{st} electronic device 410 in association with the identification information. Alternatively, the processor 416 may configure a right capable of executing a specific function in association with the identification information.

The processor 416 may establish a connection with the 2^{nd} electronic device 420 in operation 1319. For example, the processor 416 may establish a connection with the 2^{nd} electronic device 420 by using a near-distance communication method. The processor 416 may transmit a connection request to the 2^{nd} electronic device 420. In addition, the processor 416 may receive a connection response of the 2^{nd} electronic device 420. Accordingly, if the connection response of the 2^{nd} electronic device 420 is positive, the processor 416 may complete the connection with the 2^{nd} electronic device 420. Further, the processor 416 may establish the connection with the 2^{nd} electronic device 420 on the basis of a user's selection. According to an example embodiment, the processor 416 may search for a neighboring device. When the 2^{nd} electronic device 420 is found in this manner, the processor 416 may establish the connection with the 2^{nd} electronic device 420. Further, the processor 416 may establish the connection with the 2^{nd} electronic device 420 on the basis of the user's selection.

If reference information is requested from the 2^{nd} electronic device 420 in operation 1321, the processor 416 may generate the reference information in operation 1327. In operation 1329, the processor 416 may transmit the reference information to the 2^{nd} electronic device 420.

If the reference information is not requested from the 2^{nd} electronic device 420 in operation 1321, and if it is notified from the 2^{nd} electronic device 420 that the request of the reference information is canceled, the processor 416 may sense this in operation 1331. Accordingly, the processor 416 may end the operating method without having to generate the reference information.

Meanwhile, if it is not notified that the request of the reference information is canceled in operation 1331, the processor 416 may return to operation 1321.

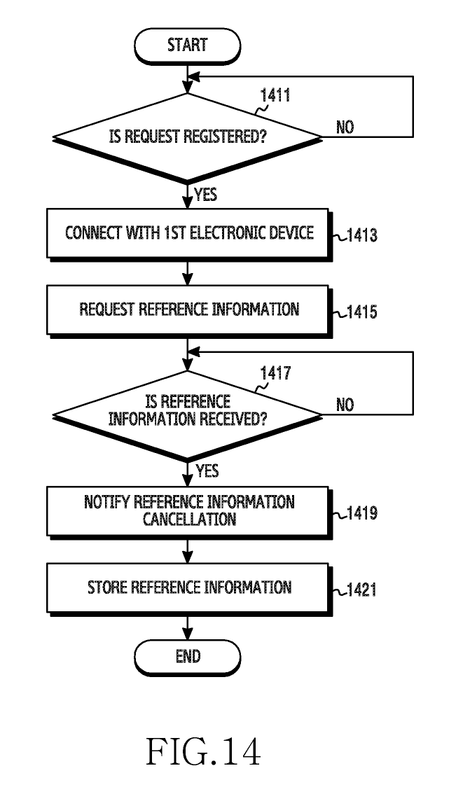

FIG. 14 is a flowchart illustrating an example method of operating the 2^{nd} electronic device 420 according to an example embodiment.

Referring to FIG. 14, in operation 1411, the processor 426 may sense a request for registering a user. That is, if the request for registering the user to the 2^{nd} electronic device 420 is generated, the processor 426 may sense this. For example, the processor 426 may sense a request for configuring the user via the input unit 422.

In operation 1413, the processor 426 may establish a connection with the 1^{st} electronic devices 410. That is, the processor 426 may establish a connection with the 1^{st} external device 1001 and the 2^{nd} external device 1002 via the communication unit 421. For example, the processor 426 may establish the connection with the 1^{st} external device 1001 and the 2^{nd} external device 1002 by using a near-distance communication method. Upon receiving a connection request from the 1^{st} external device 1001 and the 2^{nd} external device 1002, the processor 426 may determine whether the 1^{st} external device 1001 and the 2^{nd} external device 1002 are connected. In addition, the processor 426 may transmit a connection response regarding whether to be connected to the 1^{st} external device 1001 and the 2^{nd} external device 1002. Accordingly, if the connection response is positive, the processor 426 may complete the connection with the 1^{st} external device 1001 and the 2^{nd} external device 1002 in operation 1413. Further, in operation 1415, the processor 426 may request the 1^{st} electronic devices 410 for reference information.

Upon receiving the reference information from any one of the 1^{st} electronic devices 410, the processor 426 may sense this in operation 1417. That is, the processor 426 may receive the reference information from the 1^{st} external device 1001. In addition, in operation 1419, the processor 426 may notify to the remaining electronic devices among the 1^{st} electronic devices 410 that the request of the reference information is canceled. That is, the processor 426 may notify to the 2^{nd} external device 1002 that the request of the reference information is canceled. Further, the processor 426 may store the reference information in operation 1421. That is, the processor 426 may store the reference information in association with the 1^{st} external device 1001.

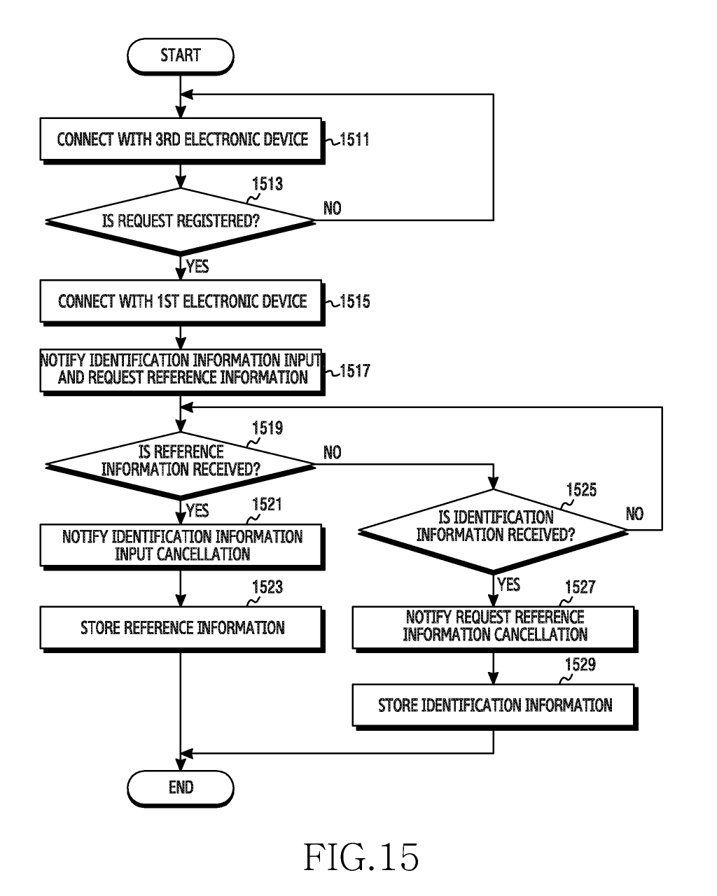

FIG. 15 is a flowchart illustrating an example method of operating the 2^{nd} electronic device 420 according to another example embodiment.

Referring to FIG. 15, in operation 1511, the processor 426 may be connected with the 3^{rd} electronic device 430. For example, the 3^{rd} electronic device 320 may be electrically connected to the 2^{nd} electronic device 420. Alternatively, the 3^{rd} electronic device 430 may be electrically connected to the 2^{nd} electronic device 420. Alternatively, the 3^{rd} electronic device 430 may be attached to the 2^{nd} electronic device 420.

In operation 1513, the processor 426 may sense a request for registering a user. That is, if the request for registering the user to the 2^{nd} electronic device 420 is generated, the processor 426 may sense this. For example, the processor 426 may sense a request for configuring the user via the input unit 422.

In operation 1515, the processor 426 may establish a connection with the 1^{st} electronic device 410. That is, the processor 426 may establish a connection with the 1^{st} electronic device 410 via the communication unit 421. For example, the processor 426 may establish the connection with the 1^{st} electronic device 410 by using a near-distance communication method. Upon receiving a connection request from the 1^{st} electronic device 410, the processor 426 may determine whether to be connected with the 1^{st} electronic device 410. In addition, the processor 426 may transmit a connection response regarding whether to be connected to the 1^{st} electronic device 410. Accordingly, if the connection response is positive, the processor 426 may complete the connection with the 1^{st} electronic device 410. Further, in operation 1517, the processor 426 may notify identification information to the user, and may request the 1^{st} electronic devices 410 for reference information. The processor 426 may notify to the user that the identification information is input, by using display data or audio data. For example, the processor 426 may output a user interface for the input of the identification information via the display unit 423.

Upon receiving the reference information from the 1^{st} electronic device 410, the processor 426 may sense this in operation 1519. In addition, in operation 1521, the processor 426 may notify to the user that an input of identification information is canceled. The processor 426 may notify to the user that the input of the identification information is canceled, by using display data or audio data. For example, the processor 426 may remove the user interface for the input of the identification information via the display unit 423. In addition, the processor 426 may store the reference information in operation 1523. That is, the processor 426 may store the reference information in accordance with the 1^{st} electronic device 410.

Meanwhile, if the reference information is not received from the 1^{st} electronic device 410 in operation 1519 and if the identification information is received from the 3^{rd} electronic device 430, the processor 426 may sense this in operation 1525. In addition, in operation 1527, the processor 426 may notify to the 1^{st} electronic device 410 that the request of the reference information is canceled. Further, in operation 1529, the processor 426 may store the identification information. That is, the processor 426 may store the identification information in association with the user of the 2^{nd} electronic device 420.

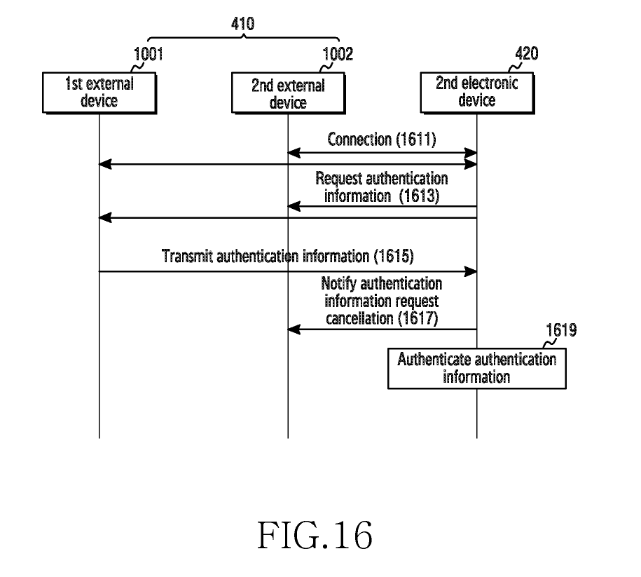

FIG. 16 is a flowchart illustrating an example method of authenticating bio information in the communication system 400 according to various example embodiments. According to various example embodiments, the communication system 400 may include the plurality of 1^{st} electronic devices 410 and the 2^{nd} electronic device 420. Any one of the 1^{st} electronic devices 410 may be the 1^{st} external device 1001 of the 2^{nd} electronic device 420, and another one of the 1^{st} electronic devices 410 may be the 2^{nd} external device 1002 of the 2^{nd} electronic device 420.

Referring to FIG. 16, in operation 1611, the 2^{nd} electronic device 420 may establish a connection with the 1^{st} external device 1001 and the 2^{nd} external device 1002. For example, if the 2^{nd} electronic device 420 is on, the 2^{nd} electronic device 420 may request a connection to the 1^{st} external device 1001 and the 2^{nd} electronic device 1002. In response thereto, the 2^{nd} electronic device 420 may establish a connection with the 1^{st} external device 1001 and the 2^{nd} external device 1002 by using a near-distance communication method. Accordingly, the 2^{nd} electronic device 420 may be connected to the 1^{st} external device 1001, and the 2^{nd} electronic device 420 may be connected to the 2^{nd} external device 1002. In addition, in operation 1613, the 2^{nd} electronic device 420 may request the 1^{st} external device 1001 and the 2^{nd} external device 1002 for authentication information.

According to various example embodiments, if the authentication information is requested from the 2^{nd} electronic device 420 in operation 1613, the 1^{st} external device 1001 may transmit the authentication information to the 2^{nd} electronic device 420 in operation 1615.

According to various example embodiments, upon receiving the authentication information from the 1^{st} external device 1001 in operation 1615, the 2^{nd} electronic device 420 may notify to the 2^{nd} external device 1002 that the request of the authentication information is canceled in operation 1617. In addition, in operation 1619, the 2^{nd} electronic device 420 may perform authentication of the authentication information.

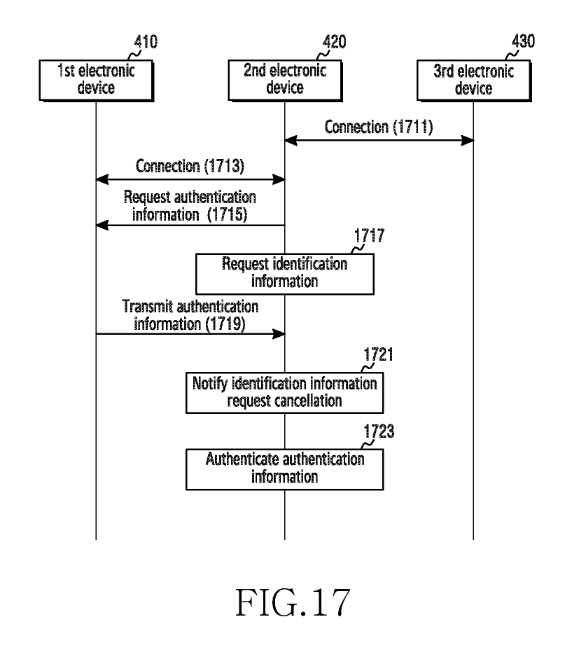

FIG. 17 is a flowchart illustrating an example method of authenticating bio information in the communication system 400 according to various example embodiments.

Referring to FIG. 17, the 2^{nd} electronic device 420 and the 3^{rd} electronic device 430 may be connected in operation 1711. For example, the 3^{rd} electronic device 320 may be electrically connected to the 2^{nd} electronic device 420. Alternatively, the 3^{rd} electronic device 430 may be electrically connected to the 2^{nd} electronic device 420. Alternatively, the 3^{rd} electronic device 430 may be attached to the 2^{nd} electronic device 420.

According to various example embodiments, in operation 1713, the 2^{nd} electronic device 420 may establish a connection with the 1^{st} electronic device 410. For example, if the 2^{nd} electronic device 420 is on, the 2^{nd} electronic device 420 may request a connection to the 1^{st} electronic device 410. In response thereto, the 2^{nd} electronic device 420 may establish a connection with the 1^{st} electronic device 410 by using a near-distance communication method. Accordingly, the 2^{nd} electronic device 420 may be connected to the 1^{st} electronic device 410. In addition, in operation 1715, the 2^{nd} electronic device 420 may request the 1^{st} electronic device 410 for authentication information. Further, in operation 1717, the 2^{nd} electronic device 420 may request the user for identification information.

According to various example embodiments, if the authentication information is requested from the 2^{nd} electronic device 420 in operation 1715, the 1^{st} electronic device 410 may transmit the authentication information to the 2^{nd} electronic device 420 in operation 1719.

According to various example embodiments, upon receiving the authentication information from the 1^{st} electronic device 410 in operation 1719, the 2^{nd} electronic device 420 may notify that the request of the identification information is canceled in operation 1721. In addition, in operation 1723, the 2^{nd} electronic device 420 may authenticate the authentication information.

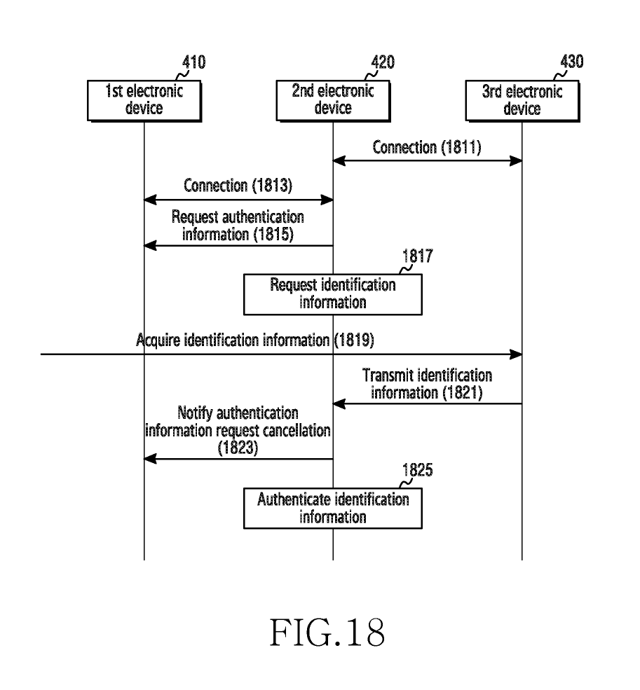

FIG. 18 is a flowchart illustrating an example method of recognizing bio information in a communication system according to various example embodiments.

Referring to FIG. 18, the 2^{nd} electronic device 420 and the 3^{rd} electronic device 430 may be connected in operation 1811. For example, the 3^{rd} electronic device 320 may be electrically connected to the 2^{nd} electronic device 420. Alternatively, the 3^{rd} electronic device 430 may be electrically connected to the 2^{nd} electronic device 420. Alternatively, the 3^{rd} electronic device 430 may be attached to the 2^{nd} electronic device 420.

According to various example embodiments, in operation 1813, the 2^{nd} electronic device 420 may establish a connection with the 1^{st} electronic device 410. For example, if the 2^{nd} electronic device 420 is on, the 2^{nd} electronic device 420 may request a connection to the 1^{st} electronic device 410. In response thereto, the 2^{nd} electronic device 420 may establish a connection with the 1^{st} electronic device 410 by using a near-distance communication method. Accordingly, the 2^{nd} electronic device 420 may be connected to the 1^{st} electronic device 410. In addition, in operation 1815, the 2^{nd} electronic device 420 may request the 1st electronic device 410 for authentication information. Further, in operation 1817, the 2^{nd} electronic device 420 may request the user for identification information.

According to various example embodiments, in operation 1819, the 3^{rd} electronic device 430 may acquire identification information from a user. That is, if the identification information is requested from the 2^{nd} electronic device 420 in operation 1817, the user may input the identification information via the 3^{rd} electronic device 430. Accordingly, the 3^{rd} electronic device 430 may acquire the identification information by using the bio sensor. In addition, in operation 1821, the 3^{rd} electronic device 430 may transmit the identification information to the 2^{nd} electronic device 420.

According to various example embodiments, upon receiving the identification information from the 3^{rd} electronic device 430 in operation 1821, the 2^{nd} electronic device 420 may notify to the 1^{st} electronic device 410 that the request of the authentication information is canceled in operation 1823. In addition, the 2^{nd} electronic device 420 may authenticate the identification information in operation 1825. For example, the 2^{nd} electronic device 420 may compare the identification information with pre-stored identification information. If the identification information is the same as the pre-stored identification information, the 2^{nd} electronic device 420 may determine that the identification information is successfully authenticated. Alternatively, if the identification information is different from the pre-stored identification information, the 2^{nd} electronic device 420 may determine that the authentication of the identification information has failed.

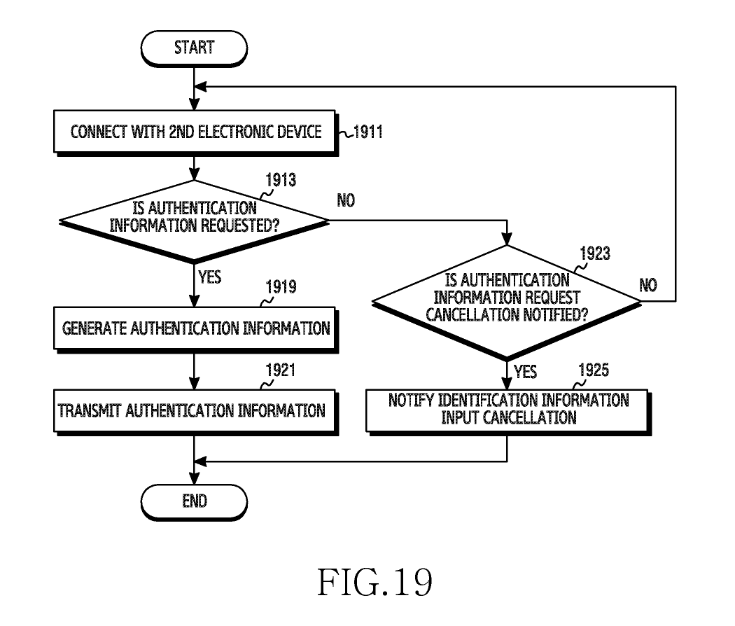

FIG. 19 is a flowchart illustrating an example method of operating the 1^{st} electronic device 410 according to various example embodiments.

Referring to FIG. 19, the processor 416 may establish a connection with the 2^{nd} electronic device 420 in operation 1911. For example, if the 2^{nd} electronic device 420 is on, the 2^{nd} electronic device 420 may request a connection to the 1^{st} electronic device 410. In response thereto, the processor 416 may establish a connection with the 2^{nd} electronic device 420 by using a near-distance communication method.

If authentication information is requested from the 2^{nd} electronic device 420, the processor 416 may sense this in operation 1913. The processor 416 may generate the authentication information in operation 1919. In operation 1921, the processor 416 may transmit the authentication information to the 2^{nd} electronic device 420.

If authentication information is not requested from the 2^{nd} electronic device 420 in operation 1913 and if it is notified from the 2^{nd} electronic device 420 that the request of the authentication information is canceled, the processor 416 may sense this in operation 1923. In addition, in operation 1925, the processor 416 may notify to the user that the input of the identification information is canceled. The processor 416 may notify to the user that the input of the identification information is canceled, by using display data or audio data. For example, the processor 416 may remove the user interface for the input of the identification information via the display unit 413.

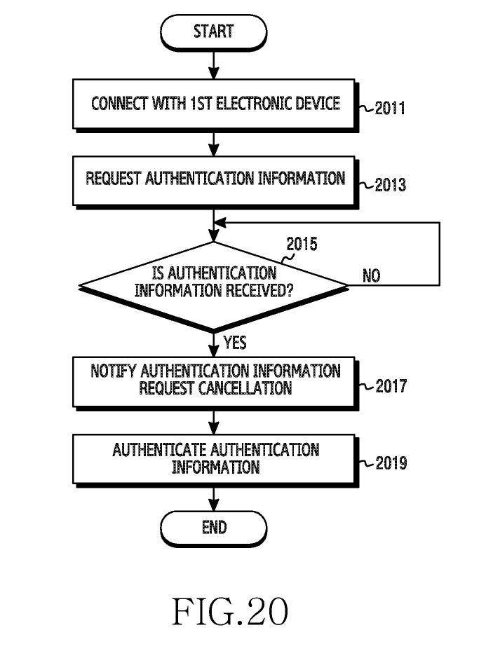

FIG. 20 is a flowchart illustrating an example method of operating the 2^{nd} electronic device 420 according to an example embodiment.

Referring to FIG. 20, in operation 2011, the processor 426 may establish a connection with the 1^{st} electronic devices 410. That is, the processor 426 may establish a connection with the 1^{st} external device 1001 and the 2^{nd} external device 1002 via the communication unit 421. For example, if the 2^{nd} electronic device 420 is activated, the processor 426 may request a connection to the 1st external device 1001 and the 2^{nd} external device 1002 by using a near-distance communication method. In response thereto, the processor 426 may establish the connection with the 1^{st} external device 1001 and the 2^{nd} external device 1002 by using the near-distance communication method. In addition, in operation 2013, the processor 426 may request the 1^{st} electronic devices 410 for authentication information.

Upon receiving the authentication information from any one of the 1^{st} electronic devices 410, the processor 426 may sense this in operation 2015. That is, the processor 426 may receive the authentication information from the 1^{st} external device 1001. In addition, in operation 2017, the processor 426 may notify the remaining electronic devices among the 1^{st} electronic devices 410 that the request of the authentication information is canceled. That is, the processor 426 may notify the 2^{nd} electronic device 1002 that the request of the authentication information is canceled. Further, in operation 2019, the processor 426 may authenticate the authentication information.

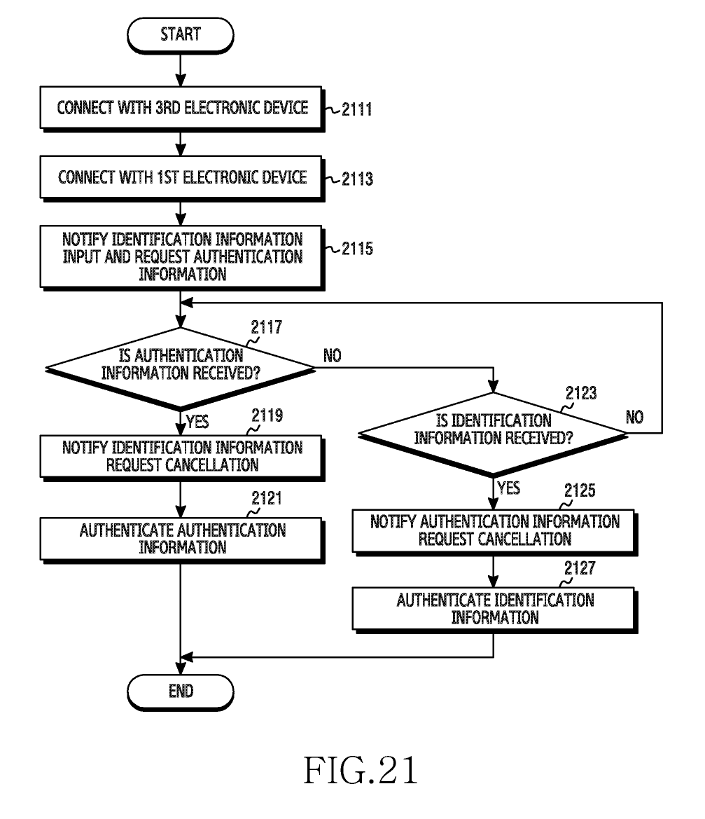

FIG. 21 is a flowchart illustrating an example method of operating the 2^{nd} electronic device 420 according to another example embodiment.

Referring to FIG. 21, in operation 2111, the processor 426 may be connected with the 3^{rd} electronic device 430. For example, the 3^{rd} electronic device 320 may be electrically connected to the 2^{nd} electronic device 420. Alternatively, the 3^{rd} electronic device 430 may be electrically connected to the 2^{nd} electronic device 420. Alternatively, the 3^{rd} electronic device 430 may be attached to the 2^{nd} electronic device 420.

In operation 2113, the processor 426 may establish a connection with the 1^{st} electronic device 410. That is, the processor 426 may establish a connection with the 1^{st} electronic device 410 via the communication unit 421. For example, if the 2^{nd} electronic device 420 is on, the processor 426 may request a connection to the 1^{st} electronic device 410 by using a near-distance communication method. In response thereto, the processor 4226 may perform the connection with the 1^{st} electronic device 410 by using the near-distance communication method. In addition, in operation 2115, the processor 426 may request the user for the identification information, and may request the 1^{st} electronic device 410 for the authentication information. The processor 416 may notify to the user that the identification information is input, by using display data or audio data. For example, the processor 416 may output a user interface for the input of the identification information via the display unit 413.

Upon receiving the authentication information from the 1^{st} electronic device 410, the processor 426 may sense this in operation 2117. In addition, in operation 2119, the processor 426 may notify to the user that the identification information is canceled. The processor 426 may notify to the user that the input of the identification information is canceled by using display data or audio data. For example, the processor 426 may remove the user interface for the input of the identification information via the display unit 423. Further, in operation 2121, the processor 426 may authenticate the authentication information.

Meanwhile, if the authentication information is not received from the 1^{st} electronic device 410 in operation 2117 and if the identification information is received from the 3^{rd} electronic device 430, the processor 426 may sense this in operation 2123. In addition, in operation 2125, the processor 426 may notify to the 1^{st} electronic device 410 that the request of the authentication information is canceled. Further, in operation 2127, the processor 426 may authentication the identification information. For example, the processor 426 may compare the identification information with pre-stored identification information. If the identification information is the same as the pre-stored identification information, the processor 426 may determine that the identification information is successfully authenticated. Alternatively, if the identification information is different from the pre-stored identification information, the processor 426 may determine that the authentication of the identification information has failed.

According to various example embodiments, a method of operating an electronic device may include connecting communication with a plurality of external devices, requesting the plurality of external devices for identification information, receiving the identification information from at least one of the plurality of external devices in response to the identification information request, and cancelling the request to at least one external device different from the at least one of the plurality of external devices on the basis of the reception.

According to various example embodiments, the method of operating the electronic device may further include activating a user interface to acquire the identification information from the plurality of external devices.

According to various example embodiments, the method of operating the electronic device may further include receiving the bio information from at least one of the external devices, and removing the user interface from the display unit.

According to various example embodiments, the method of operating the electronic device may further include acquiring the identification information, and cancelling the request to the external devices.

The term “module” used in the present document includes a unit including one or more of hardware, software, or firmware, and may be interchangeably used with a term such as a unit, a logic, a logical block, a component, a circuit, and the like. The “module” may be an integrally constructed component or a minimum unit or one part thereof for performing one or more functions. The “module” may be mechanically or electrically implemented, and may include, for example, a dedicated processor, a CPU, circuitry, an Application-Specific Integrated Circuit (ASIC) chip, a Field-Programmable Gate Arrays (FPGAs), or a programmable-logic device, which is known or to be developed to perform certain operations.

At least one part of an apparatus (e.g., modules or functions thereof) or method (e.g., operations) according to various example embodiments may be implemented with an instruction stored in a computer-readable storage media (e.g., the memory 130). If the instruction is executed by one or more processors (e.g., the processor 120), the one or more processors may perform a function corresponding to the instruction. The computer-readable storage media may include a hard disk, a floppy disk, magnetic media (e.g., a magnetic tape), optical media (e.g., a Compact Disc-ROM (CD-ROM), a Digital Versatile Disc (DVD), magnetic-optic media (e.g., a floptical disk)), an internal memory, or the like. The instruction may include a code created by a compiler or a code executable by an interpreter.

According to various example embodiments, a recording medium may record a program for executing operations of receiving an access request for the electronic device from an external electronic device, activating the authentication module in response to the access request, transmitting, to the external electronic device, an authentication information request for the authentication module, receiving, from the external electronic device, authentication information corresponding to a user of the external electronic device in response to the authentication information request, performing authentication on the user on the basis of the authentication information by using the authentication module, and deactivating the authentication module if the authentication is complete.

According to various example embodiments, a recording medium may record a program for executing operations of connecting communication with a plurality of external devices, requesting the plurality of external devices for identification information, receiving the identification information from at least one of the plurality of external devices in response to the identification information request, and cancelling the request to at least one external device different from the at least one of the plurality of external devices on the basis of the reception.

The module or programming module according to various example embodiments may further include at least one or more elements among the aforementioned elements, or may omit some of them, or may further include additional other elements. Operations performed by a module, programming module, or other elements may be executed in a sequential, parallel, repetitive, or heuristic manner. In addition, some of the operations may be executed in a different order or may be omitted, or other operations may be added.

Various example embodiments have an advantage in that a convenience is improved on the basis of user authentication since the heterogeneous electronic devices 410 and 420 provide an authentication function through bio sensing.

As described above, an electronic device and an operating method thereof according to various example embodiments have an advantage in that a convenience is improved on the basis of user authentication since the heterogeneous electronic devices provide an authentication function through bio sensing.

What is claimed is:

1. An electronic device comprising:
a display;
a communication circuit;
an authentication module; and
a processor, wherein the processor is configured to:
receive an identification request for the electronic device from an external electronic device using the communication circuit,
activate the authentication module in response to the identification request,
transmit, to the external electronic device, an authentication information request for the authentication module,
receive, from the external electronic device, authentication information corresponding to a user of the external electronic device in response to the authentication information request,
perform authentication on the user based on the authentication information using the authentication module, and
deactivate the authentication module if the authentication is complete.

2. The electronic device of claim 1, wherein the processor is configured to receive bio information corresponding to the user of the external electronic device as at least one part of the authentication information.

3. The electronic device of claim 1, wherein the processor is further configured to receive information generated based on a result of the authentication performed in the external electronic device as at least one part of the authentication information using bio information corresponding to the user of the external electronic device.

4. The electronic device of claim 1, wherein the processor is further configured to receive a non-bio information based passcode corresponding to the user as at least one part of the authentication information.

5. The electronic device of claim 1, further comprising an authentication management module comprising an authentication management circuit configured to manage the authentication module, wherein the authentication module is configured to provide a notification indicating that the authentication is complete to the authentication management module.

6. The electronic device of claim 5, wherein the processor is further configured to perform activation and/or deactivation of the authentication module using the authentication management module.

7. A method of operating an electronic device, the method comprising:
receiving an identification request for the electronic device from an external electronic device;
activating an authentication module in response to the identification request;
transmitting, to the external electronic device, an authentication information request for the authentication module;
receiving, from the external electronic device, authentication information corresponding to a user of the external electronic device in response to the authentication information request;
performing authentication on the user based on the authentication information using the authentication module; and
deactivating the authentication module if the authentication is complete.

8. The method of claim 7, wherein in the receiving of the authentication information, bio information corresponding to the user of the external electronic device is received as at least one part of the authentication information.

9. The method of claim 7, wherein in the receiving of the authentication information, information generated based on a result of the authentication performed in the external electronic device at least one part of the authentication information is received using bio information corresponding to the user of the external electronic device.

10. An electronic device comprising:
a communication unit comprising communication circuitry configured to connect with a plurality of external devices; and
a processor operatively coupled to the communication unit,
wherein the processor is configured to:
request the plurality of external devices for identification information, receive the identification information from at least one of the plurality of external devices in response to the identification information request, and
cancel, based on receiving the identification information, the request to at least one external device different from the at least one of the plurality of external devices from which the identification information is received.

11. The electronic device of claim 10, wherein the processor is further configured to transmit an instruction to activate a user interface to acquire the identification information from the plurality of external devices.

12. The electronic device of claim 10, further comprising a display unit comprising a display operatively coupled to the processor, wherein the processor is further configured to display, on the display, a user interface configured to acquire identification information.

13. The electronic device of claim 12, wherein the processor is further configured to:
receive the identification information from at least one of the external devices, and
remove the user interface from the display unit.

14. The electronic device of claim 12, further comprising:
a sensor operatively coupled to the processor,
wherein the processor is further configured to:
acquire the identification information via the sensor, and
cancel the request for identification information to the external devices.
